(19) United States
(12) Patent Application Publication
(10) Pub. No.: US 2007/0088582 A1
(43) Pub. Date: Apr. 19, 2007

(54) FINANCIAL METHODS USING A CHARITABLY INTEGRATED BUSINESS OPERATION

(75) Inventor: Gerald B. Treacy, JR., Poulsbo, WA (US)

Correspondence Address: DARBY & DARBY P.C., P. O. BOX 5257, NEW YORK, NY, 10150-5257, US

(73) Assignee: ArcLine Consulting, LLC, Poulsbo, WA (US)

(21) Appl. No.: 11/551,231

(22) Filed: Oct. 19, 2006

Related U.S. Application Data
(60) Provisional application No. 60/728,110, filed on Oct. 19, 2005.
(60) Provisional application No. 60/778,894, filed on Mar. 3, 2006.
(60) Provisional application No. 60/734,671, filed on Nov. 8, 2005.
(60) Provisional application No. 60/798,882, filed on May 8, 2006.

(51) Int. Cl. G06Q 40/00

(52) U.S. Cl. 705/4

(57) ABSTRACT

Supporting charitable giving in furtherance of a business objective of the business comprises proceeding with the business objective in response to a decision by a decision maker by performing several steps. A trust is established to achieve at least a part of the business objective, the trust having a term, the trust being either a charitable remainder trust or a charitable lead trust. One or more assets of the business are transferred to the trust. At least one asset within the trust is disposed of in furtherance of the business objective. Benefits resulting from the disposition of the at least one asset are passed from the trust while shielding the business from a tax liability due to the disposing step, if the tax liability is owing.

### CROSS-REFERENCE TO RELATED APPLICATIONS

The present application claims priority from provisional application Ser. No. 60/728,110 entitled “Tax Trusts,” filed on Oct. 19, 2005, from provisional application Ser. No. 60/734,671 entitled “Business Planning Trusts,” filed on Nov. 8, 2005, from provisional application Ser. No. 60/778,894 entitled “Business Yield Enhancement Trust,” filed on Mar. 3, 2006, and from provisional application Ser. No. 60/798,882 entitled “Charitably Integrated Business Operations,” filed on May 8, 2006, the benefit of the earlier filing dates of which is hereby claimed under 35 U.S.C. § 119(e), and each of which are further incorporated by reference.

### FIELD OF INVENTION

This invention generally relates to for-profit businesses, specifically, but not exclusively, to the use of charitable planned giving techniques to increase profitability of the businesses. More specifically, the invention relates to an improved and/or less expensive method and system for one or more of the following: 1) mergers and acquisitions; 2) selling a business asset; 3) compensation of business executives and handling other business liabilities; 4) handling income streams which are temporarily undesirable; 5) attracting and retaining top executives; 6) pre-planning for the tax consequences of a future high-income year; and 7) securing disclosure of charitable contributions made by businesses.

### BACKGROUND OF THE INVENTION

Performing charitable works by a business is generally desirable. Moreover, meeting business goals, such as increasing profits, or decreasing taxes, is also generally desirable. Currently, however, these goals have not been readily or easily integrated. It is with respect to these considerations and others that the present invention has been made. In order to understand the background of the invention, current business practices are presented below, followed by legal frameworks, structures and tools available to conduct business transactions under U.S. and Canadian law.

I. Current Business Practices

Merger and Acquisition (M&A). M&As, as they were traditionally crafted, involved considerable negative tax consequences for the acquired or selling firm, and considerable expense for the acquiring or purchasing firm. The seller or its owners recognized taxable income on the sale of its stock or assets, and the buyer's offer needed adequately to compensate the seller and owners for this expense. Often these tax considerations made otherwise viable mergers and acquisitions impractical, and drove up the purchase price even in successful M&As.

Business Asset Sales. Whenever any for-profit business (whether organized as a C or S corporation, a limited liability company (LLC), a partnership, a real estate investment trust (REIT), a Massachusetts trust, or other form of business entity) sold an asset which has appreciated in value above the business's tax basis in the asset, the business owed tax based on the amount of appreciation realized in the sale. For C corporations, this appreciation would usually be taxed as ordinary income, and for S corporations, LLCs, and partnerships, this appreciation would usually be taxed as capital gain to the business owners if the applicable holding periods were satisfied. This tax consequence is disadvantageous to the business in terms of its profitability.

Executive Compensation. Also, when a for-profit business (e.g., whether organized as a C or S corporation, a limited liability company (LLC), or a partnership, a real estate investment trust (REIT), a Massachusetts trust, or other form of business entity) compensated its executives, the business would not generate any tax savings in the form of a charitable deduction, and would not receive any community goodwill or favorable publicity as a “good business citizen.” Similarly, the business funds used to pay the executive were generally subject to the claims of creditors of the business.

Businesses' Unwanted Income. A for-profit business (e.g., whether organized as a C or S corporation, a limited liability company (LLC), or a partnership, a real estate investment trust (REIT), a Massachusetts trust, or other form of business entity) facing high income tax liability strove to reduce temporarily “unwanted” income through a variety of less effective means, including investment in complex domestic and offshore enterprises which in theory temporarily reduce income. Sometimes these income-reducing schemes were structured on a shaky legal and accounting basis. The tax consequences of the temporarily unwanted income is disadvantageous to the business in terms of its profitability.

Executive Housing. Whenever any for-profit business (e.g., whether organized as a C or S corporation, a limited liability company (LLC), or a partnership, a real estate investment trust (REIT), a Massachusetts trust, or other form of business entity) wished to attract and retain top executives, the business had a limited number of tools it could utilize to do so. None of these tools afforded a means of providing housing to the executive and his or her family while at the same time securing a charitable deduction.

Businesses' High-Income Years. Whenever any for-profit business (e.g., whether organized as a C or S corporation, a limited liability company (LLC), or a partnership, a real estate investment trust (REIT), a Massachusetts trust, or other form of business entity) had a year characterized by higher-than-average income, the business or its owners often had a higher-than average income tax liability. This tax consequence is disadvantageous to the business and its owners in terms of the expense involved.

Disclosure of Business Charitable Contributions. Under current Internal Revenue Service (IRS) and Securities and Exchange Commission (SEC) rules, corporate boards and other business managers are under generally not required to disclose details as to the charitable contributions they make, purportedly on behalf of the shareholders or owners. This left shareholders and owners virtually uninformed to a significant disposition of business assets. Commentators have observed that corporate directors and officers sometimes use the gift-giving power to further their own personal career goals by securing high-visibility charitable board positions for themselves, or to support their own personal charitable or political goals, goals which may have little or no congruence with the desires of a majority of the shareholders or the best interests of the corporation.

II. Summary of Relevant Aspects of U.S. Corporate and Tax Law.

Stock. As used herein, the terms “stock” and “equity” refer to any type of equity ownership in a business, including preferred stock, common stock, LLC units, partnership units, or the like.

C Corporations. A “C corporation” is a corporation governed by Subchapter C of Chapter 1 of Subtitle A of Title 26 of the United States Code. Subchapter C is entitled, “Corporate Distributions and Adjustments,” and contains Code Sections 301-385 (and hence includes the tax-free reorganization provisions of Code Section 368). Chapter 1 of the Code, in turn, is entitled, “Normal Taxes and Surtaxes.” Subtitle A of Title 26 is entitled, “Income Taxes.” Title 26 of the United States Code, is entitled, “Internal Revenue Code” (“Code”).

A C corporation can be either privately held (also called “closely held”), or publicly traded, with corporate stock as the (usual) unit of equity participation.

A C corporation is generally not entitled to use the (lower) capital gains tax rates, but instead reports transactions which would, in other contexts (individuals, S corps, LLCs, partnerships, etc.), constitute capital gains transactions. For example, on the sale of an appreciated capital asset, the C corporation is generally taxed on the realized appreciation at ordinary income tax rates, rather than the lower capital gains tax rates. These corporate ordinary income tax rates are set forth in Code Section 11(b), and range from 15% to 35%, in a graduated schedule.

Pass-Through Entities. Some business entities other than C corporations, including S corporations, limited liability companies, general partnerships, and limited partnerships, can utilize the lower capital gains tax rates (e.g., 15%) in some circumstances, including the sale of appreciated long-term capital assets. For these entities, the sale of certain other assets, including inventory and stock in trade, will generate ordinary income rather than capital gain, and will be taxed at the (higher) ordinary income tax rates.

S Corporations. An S corporation is a corporation which is described in Subchapter S of Chapter 1 of the Code. Subchapter S is entitled, “Tax Treatment of S Corporations and Their Shareholders.” The tax treatment of an S corporation varies in a number of ways from the tax treatment of a C corporation. Perhaps most significantly, an S corporation is a “pass-through” entity for tax purposes; that is, instead of the S corporation itself paying taxes, obtaining deductions and credits, etc., these taxes, deductions and credits “pass through” to the S corporation's owners (i.e., shareholders, as stock is the (usual) unit of equity ownership in an S corporation as in a C corporation), and is reported on the owners' federal income tax returns. Hence, the sale of an appreciated long-term capital gain asset by an S corporation would typically result in a capital gains tax passed through to the owners, for reporting on their own federal income tax returns. A sale of inventory or stock in trade would, in contrast, generally result in “pass through” tax to the owners at ordinary income tax rates. Similarly, a charitable income tax deduction generated by a charitable contribution made by an S corporation would “pass through” to the owners of the S corporation, for use on their own returns.

LLCs. A limited liability company (or “LLC”) is another type of “pass through” entity.

The units of ownership are typically described as “LLC units,” or “membership units,” and can have other names. Some LLCs are publicly traded; most appear to be privately owned.

Partnerships. A partnership is another type of “pass through” entity for tax purposes. A partnership can be organized either as a “general” partnership, in which the partners generally share profits and liabilities, or as a “limited” partnership, in which the limited partners have some protections against liability. Some partnerships are publicly traded; probably most are privately owned.

“Check the Box”. Most LLCs and partnerships can elect to be treated as a corporation for tax purposes, under the so-called “check the box” rules.

Ordinary Income Assets v. Capital Gain Assets. The Code imposes a distinction between “ordinary income assets,” such as inventory and stock in trade, the sale of which generally triggers recognition of ordinary income, and “capital assets,” the sale of which can generate (lower) capital gains tax, if the asset satisfies the applicable “holding period” and qualifies as a “long-term capital asset.”

Charitable Remainder Trusts. As further background, a Charitable Remainder Trust (CRT) under United States law and the process for paying taxes in the United States when using a CRT are presented below.

A Charitable Remainder Trust (CRT) is a “split-interest” trust qualifying under Code Section 664. CRTs are usually exempt from federal income taxation (though they are potentially subject to various other non-income taxes, such as excise taxes on self-dealing, etc.) CRTs lose their exempt status if they have any unrelated business taxable income (UBTI) at least for the year or years in which such UBTI is recognized.

Not every trust which involves a distribution stream to a non-charity and a remainder interest in charity, qualifies as a CRT under Code Section 664. The Tax Reform Act of 1969, which added Code Section 664, as well as the Treasury Regulations issued under Code Section 664, apply a number of requirements which must be satisfied to qualify as a CRT.

Assets that can be held in a CRT. Generally speaking, virtually every type of asset and ownership interest may safely and directly be transferred into a CRT. There are some important exceptions as to certain types of assets which cannot be held by a CRT. A major limitation is that CRTs cannot own Subchapter S stock (or the S corporation will lose its S status). Another problem asset is real property subject to an indebtedness, which can trigger UBTI, triggering a forfeiture (for that year at least) of the CRT's tax-exempt status (this depends a good deal on how long the debt has been in place, etc., under fairly technical rules).

CRAT v. CRUT. There are two main types of CRT—a “charitable remainder annuity trust” (or “CRAT”), and a “charitable remainder unitrust” (or “CRUT”). A principal distinction between a CRAT and a CRUT is as follows. In a CRAT, the “income” (i.e., typically the noncharitable) beneficiary receives an “annuity” (i.e., a fixed dollar amount or a fixed percentage of the initial trust corpus) each year (and this in turn can be paid in annual, semiannual, quarterly, or monthly installments). Hence, in a CRAT, the “income” beneficiary (technically, the annuitant or annuity beneficiary) is to receive the specified amount each year, regardless of the trust's investment performance, or the like.

In a CRUT, in contrast, the “income” beneficiary receives a “unitrust” amount, expressed as a percentage of the (changing) value of the trust assets, valued at a certain “valuation date” each year. Hence, if, for example, a 10% unitrust percentage is selected, then if in Year 1 the trust corpus is $1 million and in Year 2 the trust corpus is $900,000, the “income” beneficiary would receive a distribution of $100,000 for Year 1 and $90,000 in Year 2. The percentage is a proportion of the changing value of the trust corpus, and so the “income” beneficiary is not certain from year to year how large or small the distribution from the CRUT will be.

Term; Remainder Interest. Regardless of whether a CRT is a CRAT or a CRUT, if a business entity establishes the CRT, the trust term cannot exceed 20 years under current law (while if an individual creates a CRT, the trust term can be a lifetime term, or a term of years (or some combination)). However, any trust term allowed by law may be used in embodiments of the invention. Also, regardless of whether a CRT is a CRAT or a CRUT, at the end of the trust term, the trust must provide that one or more qualified charities are to receive the then-remaining trust assets. The charitable beneficiary or beneficiaries can receive their shares without restriction, or various uses and purposes can be appended to the gifts (e.g., “to be used to maintain the charity's headquarters in Stowe, Vt.”), or some combination thereof. Any restrictions must be consistent with the law, and must not so inhibit the charity from using the funds as to constitute, in effect, no gift at all.

Types of CRUT. There are at least four distinct types of CRUTs. The CRUT types are:
a “SCRUT” or “standard” CRUT—a straightforward CRUT which pays out the unitrust percentage amount regardless of trust investment performance and income;
a “NICRUT” or “net income only” CRUT—the CRUT pays the lesser of the unitrust percentage or the actual income earned;
a “NIMCRUT,” or “net income with makeup” CRUT—the CRUT pays the lesser of the unitrust percentage or the actual income earned, and for any year in which the actual income is less than the unitrust percentage, there is a “makeup” in future years for the “shortfall” from the unitrust percentage; and
a “FLIP” CRUT, or “flip” unitrust—this variety starts its life as a NICRUT or NIMCRUT, and then, upon some pre-designated event (such as the sale of a major asset), it “flips” to a SCRUT (i.e., because then it has the resources to pay the entire unitrust percentage, regardless of income).

Trustee. Who can be the Trustee of a CRT? Any individual (other than incompetents, minors, felons, etc.—the requirements are typically set forth in a state statute); any corporation having trust powers (not all do, and this will depend, as well, on state authorizing legislation); perhaps the founding business itself (or certainly its individual designees); or any combination of the foregoing or other legally qualified trustees, as co-trustees or sole trustees. The Trustee often is compensated for its service, but need not be. The Trustee can hire counsel, accountants, investment advisors, custodial agents, and anyone else (or any other firms) that can reasonably assist in the management of the Trust. The Trust document cannot direct the Trustee to invest in any particular investments or any particular manner, but rather the Trustee is to be free to invest in whatever investments the Trustee may decide, in a manner consistent with local and state law requirements, and in a manner consistent with the federal and tax laws relating to CRTs. (E.g., some trust investments—which can include puts, calls, straddles, and futures—may be deemed to be “jeopardy investments” and may trigger an excise tax under Code Section 4944). The same Trustee can serve for the entire term of the Trust, or there can be changes in personnel in any variety or format which is consistent with applicable law.

Trust Return. A CRT will typically be required to file Form 5227 with the IRS each year. The Trust may also be obligated to file additional returns, for example if it has jeopardy investments, etc.

Taxation of Trust Distributions. How is an entity taxed on the distributions it receives from the CRT? Code Section 664(b) sets forth a regime which is sometimes (but not formally) referred to as the “four-tier” system:

1—income (other than capital gains)

2—capital gains;

3—other income (e.g., tax-free municipal bond income); and

4—return of principal.

Other Miscellaneous Issues. Generally, a CRT should secure an Employer ID Number from the IRS, using Form SS-4. Investment accounts held by CRT should typically be placed in the name of the Trustee, indicating such trustee capacity.

Charitable Lead Trusts. The terms “charitable lead trust” and “CLT” refer to a type of nonexempt trust in which one or more exempt charitable organizations are entitled to receive distributions during the designated term of the trust, with the remainder interest passing at the termination of the trust term to a business or an individual or other nonexempt entity, including the business which created the CLT.

CLAT v. CLUT. There are two main types of CLT—a “charitable lead annuity trust” (or “CLAT”), and a “charitable lead unitrust” (or “CLUT”). A principal distinction between a CLAT and a CLUT is as follows. In a CLAT, the “income” (i.e., charitable) beneficiary receives an “annuity” (i.e., a fixed dollar amount or a fixed percentage of the initial trust corpus) each year (and this in turn can be paid in annual, semiannual, quarterly, or monthly installments). Hence, in a CLAT, the charitable beneficiary is to receive the specified amount each year, regardless of the trust's investment performance, or the like.

In a CLUT, in contrast, the charitable beneficiary receives a “unitrust” amount, expressed as a percentage of the (changing) value of the trust assets, valued at a certain “valuation date” each year. Hence, if, for example, a 10% unitrust percentage is selected, then if in Year 1 the trust corpus is $1 million and in Year 2 the trust corpus is $900,000, the charitable beneficiary would receive a distribution of $100,000 for Year 1 and $90,000 in Year 2. The percentage is a proportion of the changing value of the trust corpus, and so the charitable beneficiary is not certain from year to year how large or small the distribution from the CLUT will be.

Grantor CLTs and Non-grantor CLTs. A CLT can be either a grantor CLTs, as to which the business or individual creating the CLT is taxed on the CLT's income and is entitled to a charitable deduction for the creation and funding of the CLT, or a non-grantor CLT, as to which the creator of the CLT is not taxable on the CLT's income and is not entitled to a charitable deduction for the creation and funding of the CLT.

Merger and Acquisition (M&A). The terms “merger and acquisition” and “M&A” refer to both a merger or an acquisition or a combination of a merger and an acquisition, as well as any other variety of business acquisition or combination, whether involving the acquisition of equity, the acquisition of assets, or the acquisition of a combination of equity and assets. An M&A may take a variety of forms. Generally speaking, a “merger” is a transaction in which two formerly autonomous business entities become a single entity (though the process is probably seldom that clean cut). Similarly, generally speaking, an “acquisition” is the transfer of assets or ownership units, or both, of one business entity, often called, loosely, the “acquired” firm, to another business entity, often called, again loosely, the “acquiring” firm.

It is quite possible that a merger or acquisition may involve more than two firms, or may involve a division or portion of a firm rather than the firm in its entirety, or the like.

Again, generally speaking, mergers and (or) acquisitions can fall into one of two broad categories: asset sales and stock sales. And there certainly may be mergers or acquisitions that involve the sale of both assets and stock.

A stock sale involves the acquisition of the acquired firm's stock or other forms of equity units, and can often involve sales by shareholders or owners, including individual owners.

Many acquiring firms prefer not to acquire stock in the acquired firm, partly out of concern that stock ownership may carry with it liabilities, including unknown or unsuspected liabilities, that attend ownership. Instead, many firms prefer “asset sales,” (which may sometimes be called “asset purchases”—again, terminology in this whole area is generally loose and informal), which in general may help to minimize unknown or unforeseen liabilities (or even known ones). An asset sale may involve the sale of a combination of asset types, including long-term capital assets, short-term capital assets (i.e., those capital assets which have not been held by the company long enough to qualify as long-term capital assets), inventory, stock in trade, etc. They may consist of real property (both improved and unimproved), fixtures, intangibles, goodwill, tangible personal property, etc. Typically, an asset sale would involve the purchase of such assets from the “acquired” firm.

Whether the acquisition involves a stock sale (or other equity unit sale) or an asset sale, or both, some common elements include the following: (1) the acquiring firm (or its surrogates) is paying a purchase price of some sort (which may be cash, may be assets, may be promises or undertakings, may be a promissory note, or may be any combination of these and every other conceivable type of property or interest); (2) the purchase price usually must be sufficiently high to permit the acquired firm (and/or its owners) to cover the tax liability generated by the sale; and (3) the purchase price usually includes what might be called a “profit” element, which is designed to compensate the acquired firm and/or its owners, beyond expenses and tax liabilities.

Some corporate reorganizations involving mergers or acquisitions are exempt from federal income tax, if they fit within the categories of “tax-free reorganizations” set forth in Section 368 of the Internal Revenue Code (“Code”). However, given the relative narrowness of these tax-free reorganizations, as a practical matter, relatively few mergers or acquisitions in fact satisfy the Code Section 368 rules. Hence, most mergers and (or) acquisitions are taxable, in whole or part.

The tax consequences to the acquired firm or its owners will depend on a number of factors, including the nature of the assets or ownership units acquired (whether these are capital assets or ordinary income assets, e.g.), and the nature of the business entity whose stock or assets (or both) is being acquired.

Not all mergers or acquisitions which are desired in fact take place. A large number of things can “go wrong,” including the reluctance of the acquired firm or its owners to be exposed to tax liability attendant on the acquisition, and the reluctance of the acquiring firm to pay enough to make its offer attractive. Similarly, there may at times be a competition or “bidding war” between two or more would-be acquirers, or two or more acquisition potential firms. Often, the difference between a successfuil and unsuccessful bid often involves the amount of the purchase price and the amount of tax liability involved (in addition to various “sweeteners,” etc.) Mergers and acquisitions negotiations can be highly complicated, often with “everything on the table” for negotiation and resolution. Some acquisitions are welcomed by the would-be acquired firms, others are not.

III. Summary of Relevant Canadian Law.

A trust or other mechanism for receiving a donation to charity under Canadian Law may act similar to a CRT under U.S. Law. However there are some differences. IT-226R, “Gift to a Charity of a Residual Interest in Real Property or an Equitable Interest in a Trust,” issued Nov. 29, 1991 by the Canada Customs & Revenue Agency Interpretative Bulletin, sets forth the requirements that must be met for a donation of a residual interest in real property or an equitable interest in a trust to qualify for purposes of the Income Tax Act.

IT-226R provides that a gift of a residual interest in real property or an equitable interest in a trust to a registered charity or certain other organizations may qualify as a deduction in computing taxable income if donated by a corporation, under Subsection 110.9(a) of the Income Tax Act.

Trusts similar to charitable remainder trusts (CRTs) under US Internal Revenue Code Section 664 qualify under IT-226R (see subsection (3), recognizing an equitable interest in a trust created upon the transfer of any property (including real property) to a trust with the requirement that the property be distributed to a beneficiary at some future date (e.g., when an income interest of another person ends)). Gifts to charitable organizations subject to retained life estates in farms and residence properties also qualify under IT-226R.

### BRIEF SUMMARY OF THE INVENTION

In accordance with one aspect of the invention, a method supports charitable giving in furtherance of a business objective of the business. The method includes the step of proceeding with the business objective in response to a decision by a decision maker by performing at least one of several other steps. The other steps include establishing a trust to achieve at least a part of the business objective, the trust having a term, the trust being either a charitable remainder trust or a charitable lead trust, transferring one or more assets of the business to the trust, disposing of at least one asset within the trust in furtherance of the business objective, and passing benefits resulting from the disposition of the at least one asset from the trust while shielding the business from a tax liability due to the disposing step, if the tax liability is owing.

In accordance with another aspect of the invention, a method passes benefits using an established trust in furtherance of a business objective of a business, the trust being of the type having a term and one or more assets. This method comprises the steps of disposing of at least one asset within the trust in furtherance of the business objective, wherein the trust is either a charitable remainder trust or a charitable lead trust and wherein a charity is either a remainderman or a beneficiary of the trust; distributing a recurring benefit from the trust to the beneficiary over a term of the trust in furtherance of the business objective; distributing a remaining asset of the trust to the remainderman, at an end of the term of the trust; and shielding the business of a tax liability due to the disposing step, if the tax liability is owing.

In accordance with another aspect of the invention, a method supports charitable giving by a business in furtherance of a business objective. This method comprises the steps of granting to a charity a remainder interest in a real property; reserving to the business or to another entity either a life estate or a term of years estate in the real property; permitting one or more persons to live on the real property in furtherance of the business objective, wherein the business objective relates to an employment of any of the one or more persons; and providing to the charity a full possession of the real property upon the occurrence of an end of either a measuring life of the life estate or the end of the term of years.

In accordance with another aspect of the invention, a method supports charitable giving by a business. This method comprises the steps of granting, by the business to a charity, an option to purchase an equity interest in the business at a bargain price; determining if an exercise condition or an event of the option occurs. If the exercise condition or the event of the option occurs, then the business tenders to the charity the equity interest; and the business receives from the charity the bargain price. Moreover, the business receives an income tax deduction for tendering the equity interest upon the charity's exercise of the option

Accordingly, one or more advantages can be had depending on the steps to implement various aspects, including:

A business can engage in a merger & acquisition while minimizing current taxes.

A business can sell appreciated assets without owing current taxes.

A business can increase its favorable publicity and goodwill by assisting charitable organizations, including the business's own charitable foundation.

A business can make up the amounts passing to charity under the invention through the use of life insurance.

A business can provide for the compensation of its executives and other employees while at the same time increasing the business's favorable publicity and goodwill by assisting charitable organizations, including the business's own charitable foundation.

The finding mechanism used to find the compensation of the executive or other employee enjoys some protection from the claims of creditors of the business.

A business can temporarily shift unwanted income to charity.

A business can recruit and retain top executives, or directors, and their families, or can incentivize retirement or departure from the firm, with a life estate in a home and land.

A business can plan in advance for significant charitable deductions in future high-income years.

Shareholders and other business owners can require the disclosure by the board of directors, officers, or managers of charitable contributions made on behalf of the business.

Shareholders and other owners can help ensure against the misuse of charitable contributions to further the career and philanthropic goals of management, rather than the best interests of the business.

These and other aspects, features and advantages of the present invention can be more fully understood from the accompanying drawings and description of certain embodiments thereof.

### DESCRIPTION OF THE DRAWINGS

Non-limiting and non-exhaustive embodiments of the present invention are described with reference to the accompanying drawings. In the drawings, like reference numerals refer to like parts throughout the various figures unless otherwise specified.

FIG. 1A illustrates one arrangement in which the present invention can operate;

FIG. 1B illustrates one example of a logic flow for supporting charitable giving by a business in furtherance of a profit objective of the business;

FIG. 2A illustrates one example of a process for managing a M&A Trust;

FIG. 2B illustrates one example of a logic flow for managing a M&A Trust;

FIG. 3A illustrates one example of a process for managing a Business Asset Sale Trust;

FIG. 3B illustrates one example of a logic flow for managing a Business Asset Sale Trust;

FIG. 4A illustrates one example of a process for managing a Business Executive Compensation Trust;

FIG. 4B illustrates one example of a logic flow for managing a Business Executive Compensation Trust;

FIG. 5A illustrates one example of a process for managing a Business Income-Shifting Trust;

FIG. 5B illustrates one example of a logic flow for managing a Business Income-Shifting Trust;

FIG. 6A illustrates one example of a process for managing an Executive Life Estate Plan;

FIG. 6B illustrates one example of a logic flow for managing an Executive Life Estate Plan;

FIG. 7A illustrates one example of a process for managing a Business Charitable Equity Options for high-income years;

FIG. 7B illustrates one example of a logic flow for managing a Business Charitable Equity Options for high-income years;

FIG. 8 illustrates one example of a logic flow for managing a Shareholder Protection Tool for Disclosure of Business Charitable Contributions; and

FIG. 9 illustrates a process for determining whether to perform a business transaction using a Charitably Integrated Business Operation (CIBO™) based on a value calculation, in accordance with the present invention.

### DETAILED DESCRIPTION OF CERTAIN EMBODIMENTS

The present invention is described more fully hereinafter with reference to specific illustrative embodiments. This invention may, however, be embodied in many different forms and should not be construed as limited to the embodiments set forth herein; rather, these embodiments are provided so that this disclosure will be thorough and complete, and will fully convey the scope of the invention to those skilled in the art. The methods may involve one or more entities (including a person, business, non-profit, computer device, or the like) performing some or all parts of an action, or set of actions. The entities may communicate in-person, over a network, including a computer network, or the like. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrases “in another embodiment” or “in an alternate embodiment” as used herein does not necessarily refer to a different embodiment, although it may. Thus, as described below, various embodiments of the invention may be readily combined, without departing from the scope or spirit of the invention.

In addition, as used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “decision maker” refers to a director, an officer, an employee, a committee, a partner, a general partner, a manager, a member, a trustee, trustee in bankruptcy, agent, attorney-in-fact, advisor, singly or in any combination, who or which is in a position to make decisions for or on behalf of a business or affecting a business.

The term “asset” means an item of property in which the business owns or holds an ownership interest or beneficial interest, directly or indirectly, and encompasses all forms and varieties of assets, including without limitation, partial interests, undivided interests, jointly held interests, co-tenancy interests, stock, equity interests, tangibles, real estate, personality, as well as intangibles of every variety and description, including without limitation goodwill, paper, interests in litigation, records, intellectual property, and investment interests.

The terms “stock” and “equity” refer to any type of equity ownership in a business, including preferred stock, common stock, LLC units, partnership units, or the like.

The term “strawman” refers to any surrogate, agent, or designee of an entity.

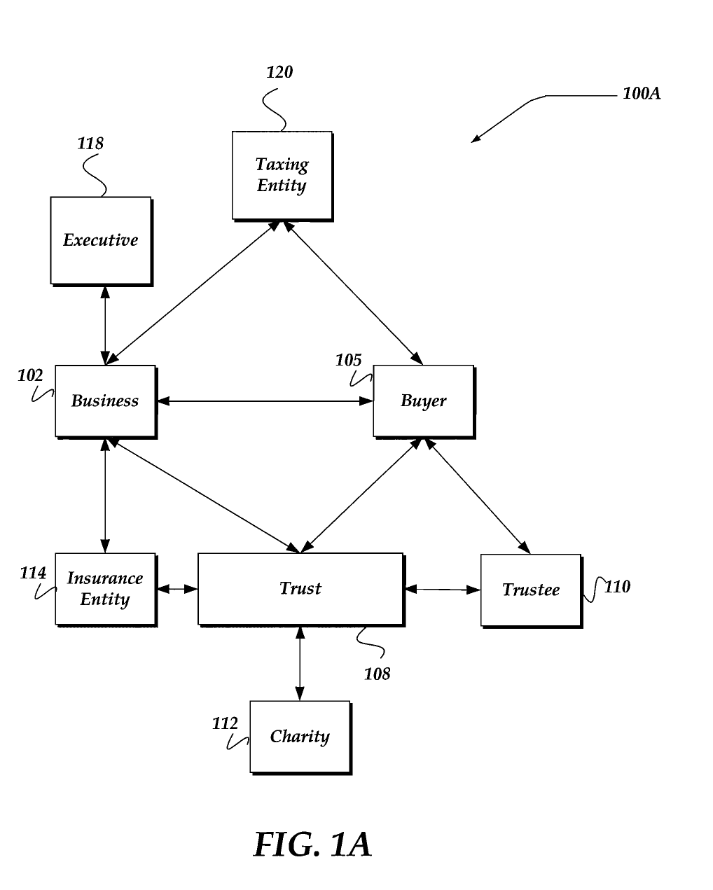

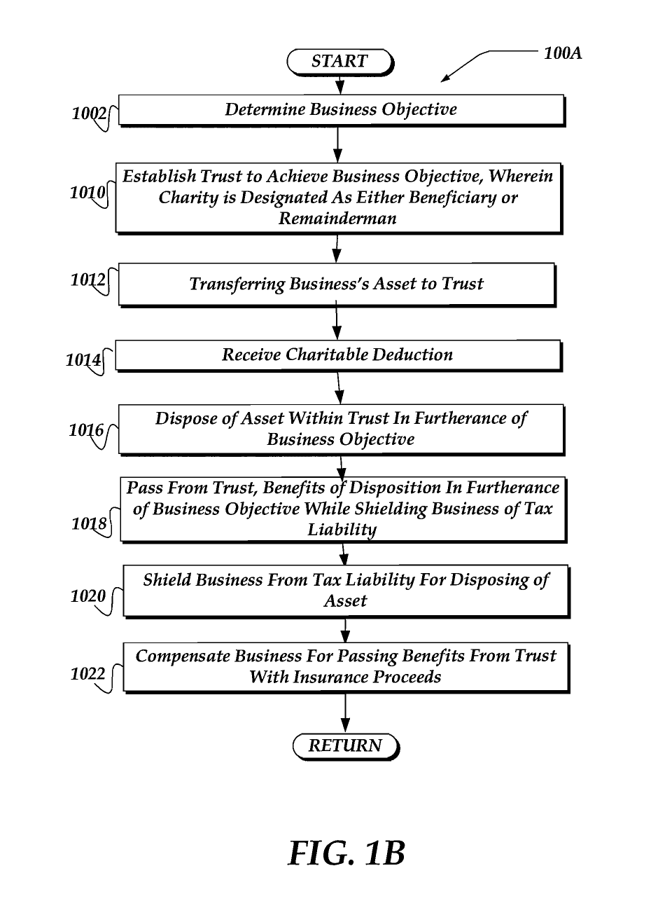

FIG. 1A illustrates one arrangement in which the present invention can operate. As shown, a system 100A of FIG. 1A operates with Business 102, Buyer 105, Trust 108, Trustee 110, Charity 112, and Insurance Entity 114. In some embodiments, at least some components of system 100, including Buyer 105 and Insurance Entity 114, may be omitted without departing from the spirit of the invention. In some embodiments, system 100A may include more than one charity, buyers, trusts, trustees, or the like.

As shown, Trust 108 is in communication with Business 102, Buyer 105, Trustee 110, Charity 112, and Insurance Entity 114. Trustee 110 is in further communication with Buyer 105. Business 102 is in further communication with Insurance Entity 114 and Buyer 105. Business 102 is in communication with Executive 118.

System 100A is arranged to enable Business 102 to be more successful (e.g., more profitable) by integrating charitable planned giving into its business practices. Business 102 may use one or more Charitably Integrated Business Operations (CIBO), as described herein.

Business 102 includes any and all types and varieties of business entities, including without limitation, C corporations, S corporations, Limited Liability Corporations (LLCs), limited partnerships, general partnerships, real estate investment trusts (REITs), Massachusetts trusts, and/or virtually any other entity allowed by law. Business 102 is configured to integrate charitable planned giving into its business practices. The business practices may include a sale of an asset, funding a liability, paying an employee, or the like. As such, Business 102 may set up a trust and/or other mechanism to benefit a charity and to minimize a cost of its business practices, including minimizing tax consequences.

In some embodiments of the invention, Business 102 receives a charitable deduction for gifting or transferring an asset, right, or the like, to Charity 112. The precise nature of the charitable deduction available to Business 102, will depend on the form of business involved. A C corporation generally takes the deduction on its own return, against its own business income. In a “pass-through” entity such as an S corporation, LLC or partnership, the deduction generally is “passed through” to the owners for use on their own income tax returns (whether the owners are individuals or businesses).

Buyer 105 includes any business which may wish to buy at least some assets, stocks, or the like, from Business 102. Buyer 105 includes a person, persons, any and all types and varieties of business entities, or any other entity allowed by law. In transacting with Business 102, Buyer 105 wishes to minimize the cost of the purchase, including minimizing tax consequences. Buyer 105 may also wish to fund its own charity.

Trust 108 includes any mechanism for holding an asset for a beneficiary, and managed by a trustee (e.g., Trustee 110). Trust 108 may be established directly or indirectly by Business 102. For example, Business 102, through a surrogate party, may establish Trust 108. Trust 108 may hold its funds in a financial institution, such as a bank, or the like. Trust 108 may include any charitable remainder trust which qualifies under U.S. Internal Revenue Code 664 and/or under Canadian IT-226R, or a charitable lead trust, or virtually any other mechanism for holding an asset for a beneficiary and enabling a trustee to manage the asset. In general, Trust 108 is any mechanism for holding an asset for a beneficiary accepted by U.S. or Canadian Law, the IRS and/or created by future amendment to the Code or Treasury Regulations, or recognized in a Revenue Ruling, private letter ruling, technical advice memorandum, general counsel memorandum, or court decision, or any future way of communicating acceptability or permissibility

A recurring beneficiary/ies may receive an income stream, or other recurring benefit from Trust 108, receive a right to use an asset held by Trust 108, receive a remainder of assets, rights or interests held by Trust 108, or the like. A remainderman beneficiary receives the remainder of the assets, rights, or interests. As used herein, the term “remainderman” refers to a remainderman beneficiary, while the term “beneficiary” refers to all other beneficiaries.

Trustee 110 includes any entity which controls the funds of Trust Fund 108 for at least one beneficiary. Trustee 110 can include an individual, a bank, a trust company, or other corporate fiduciary, any combinations of entities (as co-trustees), more than one from a particular category (as co-trustees), or the like. In at least some embodiments, Trustee 110 can be Buyer 105, Business 102, or any other entity.

Charity 112 includes any organization qualifying under local, state, federal (e.g., U.S. or Canadian) law for performing charitable works. Charity 112 includes may include a public charity under Code Section 509(a)(1), (2), a supporting organization under Code Section 509(a)(3), a private operating foundation (POF) under Code Section 4942(j), a private foundation under Code Section 509(a), or the like.

Executive 118 includes an employee of Business 102 who has some control over Business 102. Although shown as an executive, Executive 118 may be also any other type of employee, without departing from the scope of the invention.

Taxing Entity 120 includes any governmental entity capable of taxing a business, person, or other entity. Taxing Entity 120 includes the U.S. Internal Revenue Service (IRS), state and local taxing agencies, Canadian taxing agencies, or the like.

Insurance Entity 114 includes any business entity enabled to provide life insurance policies. Insurance Entity 114 may provide, among other things, life insurance for Executive 118, with Business 102 as a beneficiary upon the death of Executive 118. Insurance Entity 114 may provide insurance proceeds, or an annuity or deferred annuity, to compensate the business for the “loss” of the remaining trust corpus to charity at the end of Trust 108's term. As used herein, the term “insurance proceeds” refers to any payment made with regard to a life insurance or similar product, including an annuity payment. Business 102 may determine the need for such insurance during a business transaction involving, among other things, the use of Trust 108 to benefit Charity 112. Business 102 may find there is a need elsewhere in the business, for liquidity or other reason, to secure insurance during or about the same time as Trust 108 is created, for payout during or about the same time as Trust 108's term ends. Any such insurance can be spread out over a number of executives, owners, and/or employees. Such insurance may or may not constitute “corporate owned life insurance”, or COLI. At least in some embodiments, the use of Insurance Entity 114 is optional, and Business 102 may not purchase life insurance on the lives of its employee(s). In one embodiment, insurance polices may be secured for more than one employees or persons on whose lives Business 102 has an insurable interest, without departing from the scope of the invention.

Components of system 100A may be an entity (person, business, or any other legal entity) or may, in some cases, be a computer device configured to perform at least some of the actions, on behalf of a person, business, or any other legal entity, as described herein. The computer device(s) may be configured with hardware and/or computer readable medium (e.g., software) for performing the actions. Components of system 100A may be in communication with each other over a variety of mechanisms, including, over a computer network, a wireless network, over a telephone network, in-person, or the like. Hence, the arrangement of system 100A can include any mechanism for communicating data over a network, including computers, mobile devices, embedded devices or the like. Any components used can provide user interfaces (including Hypertext Markup Language (HTML)/eXtensible Markup Language (XML)/Hypertext Transfer Protocol (HTTP) interfaces) to a user to control the device, or can operate automatically or semi-automatically under program control. The components of system 100A communicate with each other over a network, such as a Local Area Network (LAN), Wide Area Network (WAN), the Internet or the like. Alternatively, one or more components communicate with each other through a direct connection. In some embodiments, some components can be hosted on the same device and communicate through a data bus, memory, or the like.

Generalized Operations

FIG. 1B shows a process for supporting of charitable giving by a business in furtherance of a profit objective of the business. Process 100B of FIG. 1B may be performed by at least some of the components of system 100A of FIG. 1A.

Process 100B begins at step 1002, where a business objective of Business 102 is determined. In one embodiment, the business objective is at least one of the following: compensating an executive of the business, housing an executive, satisfying a liability of the business, completing a merger or acquisition, completing an asset sale, shifting an unwanted income stream through a charity, or the like. Determining the business objective may involve negotiating with Buyer 105 for a sale of an asset of Business 102. Next, Business 102 proceeds with the business objective in response to a decision by a decision maker by performing at least one of steps 1010, 1012, 1014, 1016, or 1018.

Processing next continues to step 1010, where Business 102 establishes Trust 108 to achieve at least a part of the business objective, the trust having a term. Trust 108 may include a charitable remainder trust, a charitable lead trust, or virtually any trust mechanism. In an alternate embodiment, Business 102 may establish more than one trust to achieve at least a part of the business objective (each with a different term of years, or each with a different payout, or each with a different CRT variety, or any and every combination thereof).

Business 102 or a third-party (e.g., any surrogate, agent, or designee of Business 102—sometimes referred to as a “strawman”, or Trustee 110) designates Charity 112 as either one of a beneficiary of a recurring benefit from Trust 108, or a remainderman of Trust 108. Business 102 or a third-party (e.g., any recipient to whom a liability of Business 102 is owed, Executive 118 or another employee of Business 102, Buyer 105, or a surrogate or designee of any of the components of FIG. 1A) may be designated as the other one of the beneficiary or the remainderman of Trust 108. Because there is no requirement that Business 102 be designated as the beneficiary of Trust 108, Business 102 can name as the beneficiary, any third-party, including any person or entity which has sold Business 102 an asset or rendered Business 102 some service for which Business 102 is paying via Trust 108, or a division or subsidiary, or as funding of the purchase price of an business transaction, such as an M&A, or the like. Moreover, any other third-party may be designated as a co-beneficiary or co-remainderman of Trust 108.

In one embodiment, at step 1010, where the business objective is to complete an asset sale of the one or more assets, to complete a merger or acquisition of assets, or to satisfy a liability of the business, Trust 108 is established as the charitable remainder trust. In this embodiment, the charitable remainder trust is a tax-exempt entity, and Charity 112 is a remainderman of the Trust 108 entitled to a remaining asset and/or a remainder interest in at least a portion of a value of the one or more transferred assets.

In one embodiment, at step 1010, where the business objective is to shift an unwanted income stream through Charity 112, Trust 108 is established as the charitable lead trust. In this embodiment, Charity 112 is a beneficiary of Trust 108 entitled to distributions from Trust 108 in the form of an annuity or a percentage of a value of assets of Trust 108, and Trust 108 is a taxable entity and the charity being a tax-exempt entity.

In one embodiment, at step 1010, Business 102 may also provide in a trust governing document, powers to Trustee 110, including that Trustee 110 is empowered to dispose of Trust 108's assets—e.g., to sell the one or more assets without incurring a tax liability to the business, in return for a payment (e.g. funds or other assets), and/or to use the payment to provide a recurring benefit of Trust 108.

It will be clear to attorneys skilled in the art of tax and/or estates and trusts law how to establish Trust 108. For example, establishing Trust 108 may include obtaining an employer identification number from the IRS for Trust 108, drafting a governing trust document that identifies, among other things, the trustee, the powers of the trustee, the rights of the beneficiaries, the rights of the remainderman, or the like. The formal requirements of Trust 108 may vary based on the type of Trust 108.

In one embodiment, at step 1010, Business 102 may use a computing device to perform at least some of the steps of establishing Trust 108 to achieve at least a part of the business objective. For example, the computing device may be configured to enable Business 102 to select a beneficiary, remainderman, trust type (charitable remainder trust, charitable lead trust, etc), trust term, trustee, or the like. The computing device may provide a user interface over a network, over a web interface, or the like. The computing device may store Business 102's selections in a database, or the like. The computing device may also communicate with other components of system 100A, such as Trustee 110, to notify the other components that the trust has been established.

Processing next continues to step 1012, where Business 102 transfers the assets and/or ownership units of Business 102 to Trust 108. In one embodiment, Business 102 may transfer the assets/units to Trust 108 before there exists a contractual obligation to buy or sell the asset/units. Business 102 may do this because the IRS has expressed concern that sellers who have already contractually committed themselves to sell, cannot, after signing the sales documents, belatedly transfer the assets into Trust 108. To do so, according to the IRS (at least in the individual context) is tantamount to selling the asset first, incurring tax on the sale, and then making a contribution to Trust 108.

In one embodiment, Trust 108 need not (but can) be funded with one or more assets that Business 102 wishes to sell. Hence, Trust 108 can be funded with assets that Business 102 does not wish Trustee 110 to sell, or with assets Business 102 wishes to have sold, or any combination, with some funded assets to be sold, some to be retained, some that may be sold or not, or the like.

In one embodiment, no more than 90% of the assets and/or ownership interest of Business 102 are contributed to Trust 108. While this limit is suggested in the Final Regulations issued by the Department of the Treasury under Code Section 337, in another embodiment a higher limit or even all assets may be contributed to Trust 108 without departing from the scope of the invention.

In one embodiment, at step 1012, Business 102 may use a computing device to perform at least some of the steps of transferring the assets and/or ownership units of Business 102 to Trust 108. For example, the computing device may be configured to enable Business 102 to transfer electronic funds, or the like, to an account managed by Trust 108/Trustee 110.

Processing next continues to step 1014, where Business 102 or its owners receives a charitable deduction (including income tax deductions, exemptions or credits) for funding Trust 108—e.g., transferring the one or more assets to Trust 108. In one embodiment, Business 102 or its owners may take the charitable deduction/income tax deduction on a tax return filed with a state or federal government. In one embodiment, where Business 102 is a pass-through entity, the income tax deduction may be apportioned among the owners of Business 102. It will be clear to attorneys skilled in the art of tax law that the apportionment may be pro-rata based on an owner's amount of ownership of the business, for example. In one embodiment, step 1014 is optional and may not be performed.

Processing next continues to step 1016, where Trust 108 (through Trustee 110) disposes of at least one asset within Trust 108 in furtherance of the business objective. Disposing may include selling, leasing, licensing, or investing at least one asset, granting to an entity, a right to reside on a real property, wherein the real property is one of the assets in the trust, or the like. In one embodiment, disposing may comprise performing a tax-exempt sale of the at least one asset. In one embodiment, at step 1016, where the business objective is to shift an unwanted income stream to or through Charity 112, disposing may also comprise distributing the unwanted income stream to Charity 112.

In one embodiment, at step 1016, Trust 108 (through Trustee 110) may use a computing device to perform at least some of the steps of disposing of at least one asset within Trust 108 in furtherance of the business objective. For example, the computing device may be configured to enable Trust 108 (through Trustee 110) to send electronic messages (including emails, Short Message Service (SMS), or the like) to a buyer of the asset, provide a listing for an online sale of the asset, or the like.

Processing next continues to step 1018, where at least one of the benefits resulting from the disposition of the at least one asset is passed from Trust 108 in furtherance of the business objective, while shielding Business 102 of any tax liability due to the disposing of the at least one asset. In one embodiment, passing the benefits may include distributing to the beneficiary at least one of the benefits over the term of Trust 108, and distributing to the remainderman a remaining asset of Trust 108 at the end of the term of Trust 108. It will be clear to one skilled in the art how to distribute recurring benefits or remaining assets. For example, distributing may include depositing an amount of money into the recipient's bank account, or otherwise providing the money, granting and/or recording a deed, or virtually any other method for providing assets.

In one embodiment, distributing the remaining asset may include the steps of: (1) Trust 108 pays any remaining funds which may still be owing to the beneficiary (e.g., if Trust 108 has not yet paid the final installment owing, or if due to a revaluation of assets, it is determined Trust 108 has underpaid the beneficiary); (2) Trust 108 pays any outstanding valid debts, expenses, etc.; and then (3) Trust 108 (through Trustee 110) distributes the remaining asset to the remainderman.

In another embodiment, at step 1018, passing the benefits may include receiving by Business 102, a charitable deduction (e.g. charitable income tax deduction) of a present value of the remainder interest in at least a portion of a value of the one or more transferred assets and/or remaining asset of Trust 108. In one embodiment, where the business objective is to shift an unwanted income stream through Charity 112, passing the benefits may comprise providing a savings to Business 102 through a reduction of an income tax liability of Business 102. In one embodiment, the value of the trust assets may be revalued annually during Trust 108's term.

In another embodiment, where the business objective is to satisfy a liability of Business 102, passing the benefits may include 1) passing the benefits at a general temporal alignment with any payments due on the liability and/or 2) satisfying the liability based at least in part a portion of the passed benefits. For example, the benefits may pass at or near a time when one or more of the payments are due for the liability, or in increments and in a size series that relates to the payments due on the liability, such as quarterly distributions for some or all of three monthly payments.

In one embodiment, at step 1018, Trust 108 (through Trustee 110) may use a computing device to perform at least some of the steps of passing the benefits resulting from the disposition of at least one asset passed from Trust 108 in furtherance of the business objective. For example, the computing device may be configured to enable Trust 108 (through Trustee 110) to make electronic deposits into the accounts of the beneficiary and/or the remainderman. The computing device may automatically and/or periodically make the deposits for recurring benefits and/or provide electronic alerts (emails, SMS, etc), to Trust 108 to provide the recurring benefits to the beneficiary.

Processing next continues to step 1018, where Business 102 is shielded from a tax liability due to the disposing step 1016 if the tax liability is owing. Business 102 may be shielded from the tax liability based on the characteristics of Trust 108—e.g. based on whether Trust 102 is a CRT, a CLT, or a trust of particular variety of CRT or CLT, as described herein. For example, in the case where Trust 108 is a CRT, any sale by Trust 108 shields Business 102 from the tax liability.

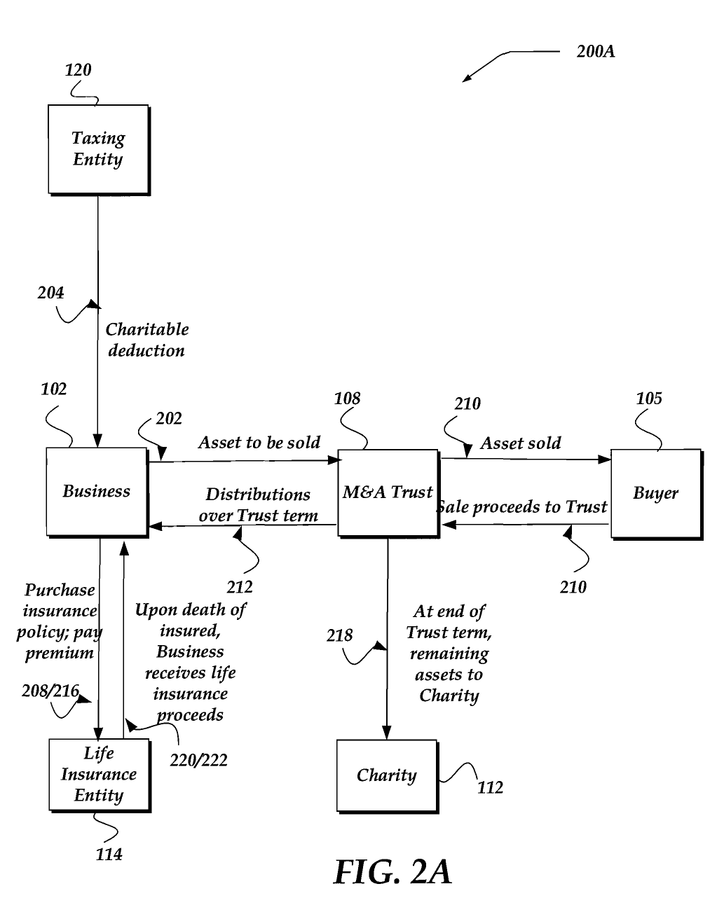

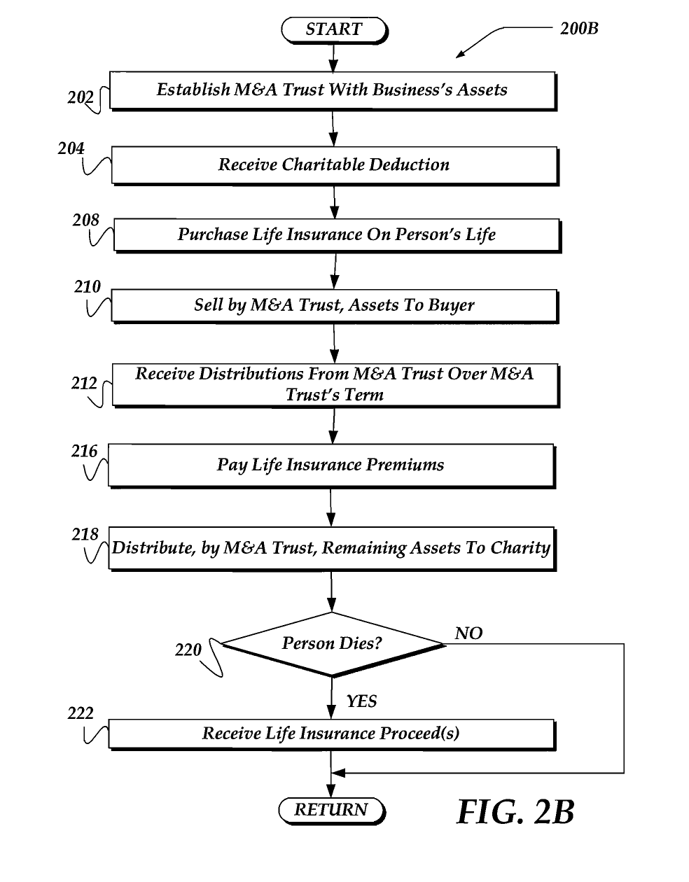

Processing next continues to step 1018, where Business 102, an employee of Business 102, a surrogate or designee of Business 102 (e.g., a strawman), or the like, are compensated for passing of at least one of the benefits from Trust 108. In one embodiment, the compensation is for distributing (a distribution of) a remaining asset of Trust 108 to the remainderman, or the like. The process of compensating Business 102, a strawman of Business 102, or the like, includes at least some of the steps of 1) purchasing a life insurance policy for a life of a person (e.g. Executive 118) in whose life Business 102 has an insurable interest; 2) paying at least one premium on the life insurance policy; and 3) collecting a proceed from the life insurance policy upon a death of the person. The process of compensating Business 102 or a strawman of Business 102 by securing an insurance policy is described in more detail below in conjunction with steps 208, 216, 220, and 222 of FIG. 2. One skilled in the business art will recognize several methods for securing an insurance policy, including choosing a type of insurance policy, choosing an insurer, choosing a length or period of an annuity provided by the insurance policy, or the like. Processing then continues to other steps.

Process 100B is a generalization of at least some of the embodiments described herein. More specific, alternate, and/or other embodiments are described below.

As described in process 100B and other processes below, Business 102 may perform several actions, including establishing Trust 108, life-estate, or term of years estate, receiving a benefit or remainder asset from Trust 108, establishing or receiving benefits from an insurance policy, or the like. The actions performed by Business 102 may also be performed by a strawman of Business 102 in the processes below, unless the circumstances dictate otherwise, without departing from the scope of the invention. Moreover, a strawman of Buyer 105 and/or Charity 112 may perform at least some of Buyer 105's and/or Charity 112's actions without departing from the scope of the invention.

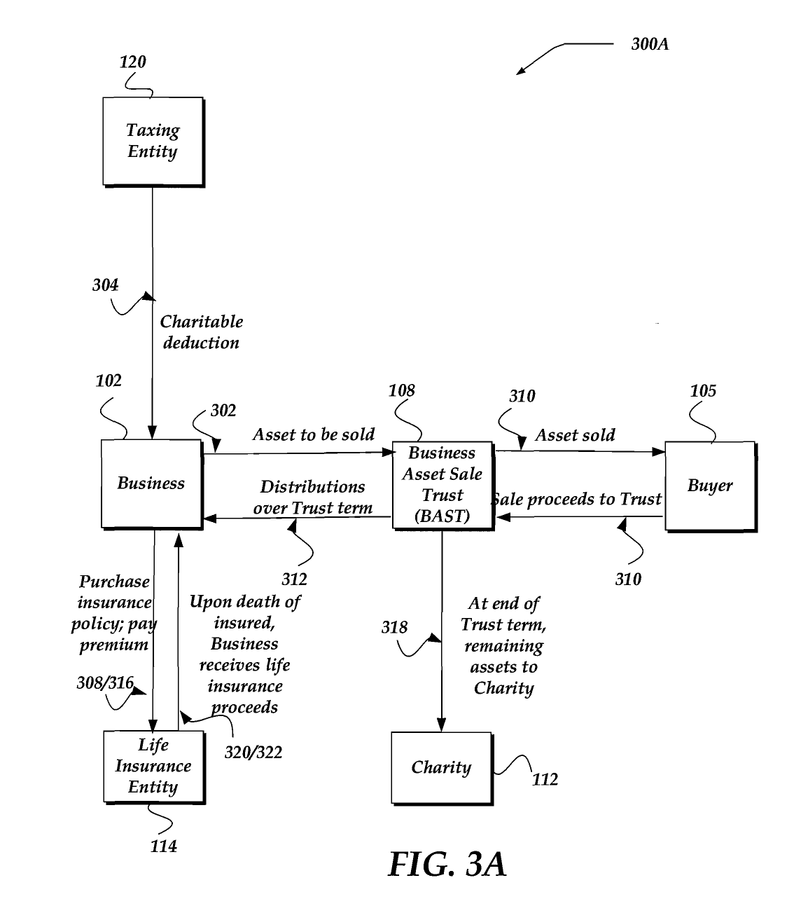

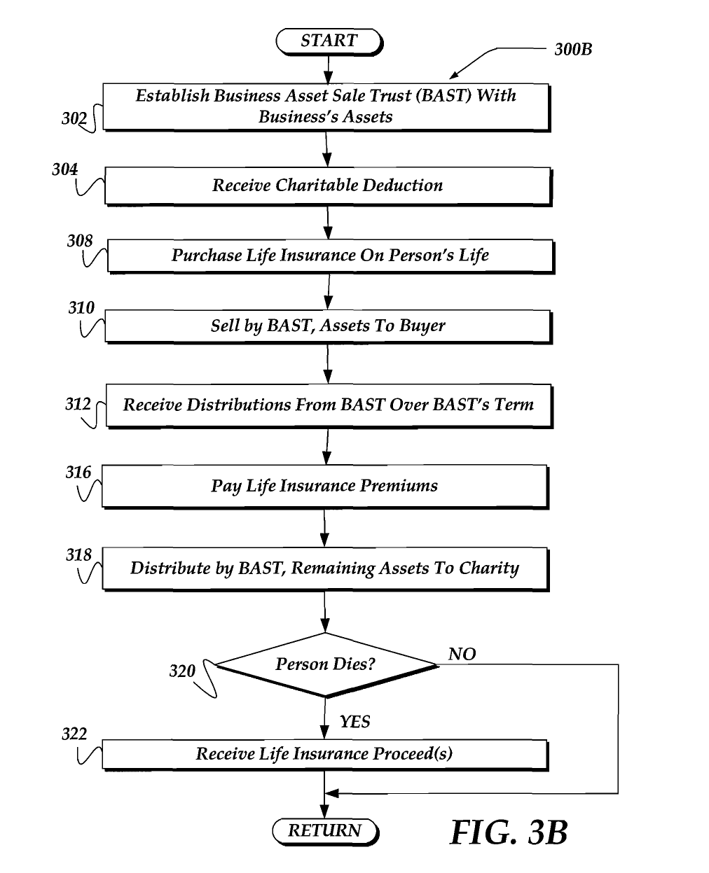

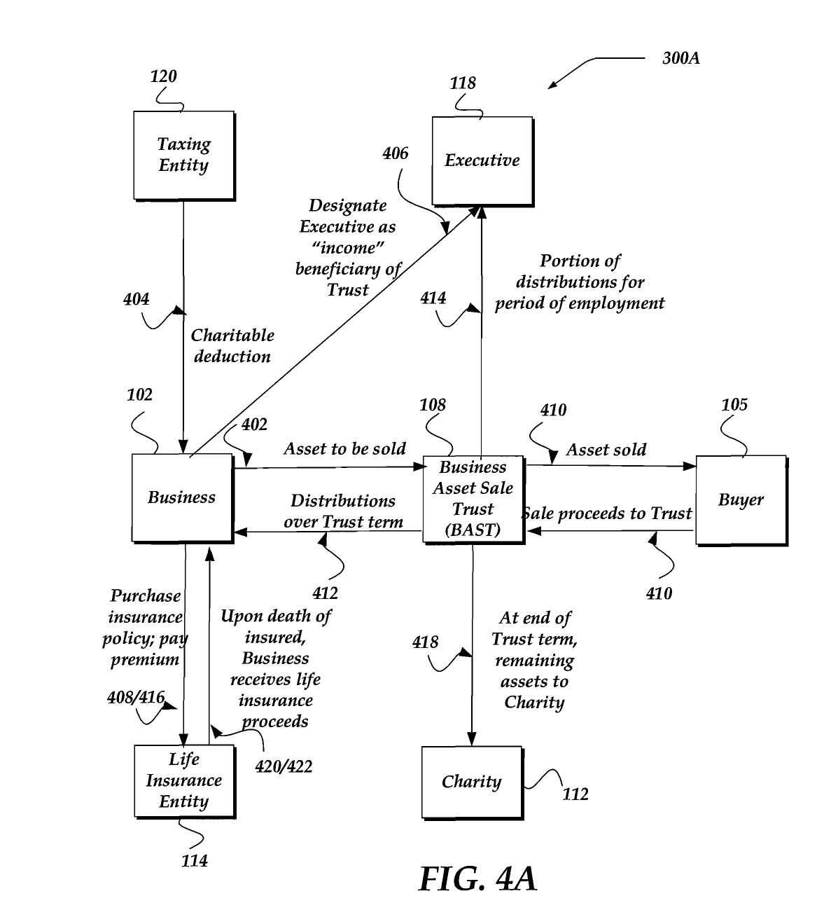

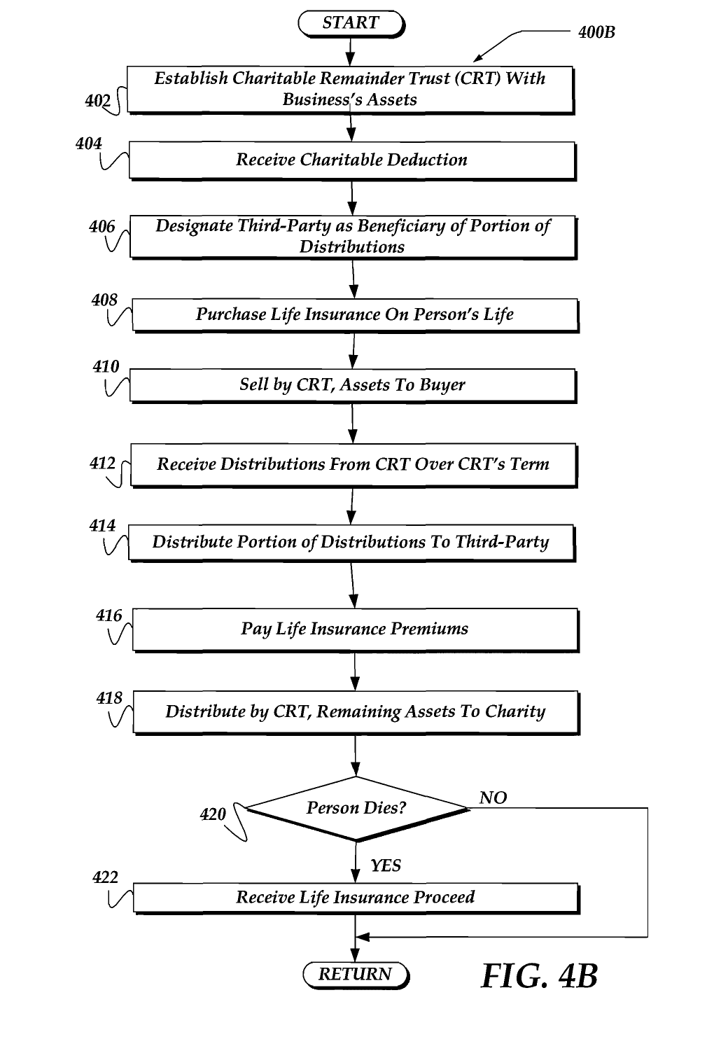

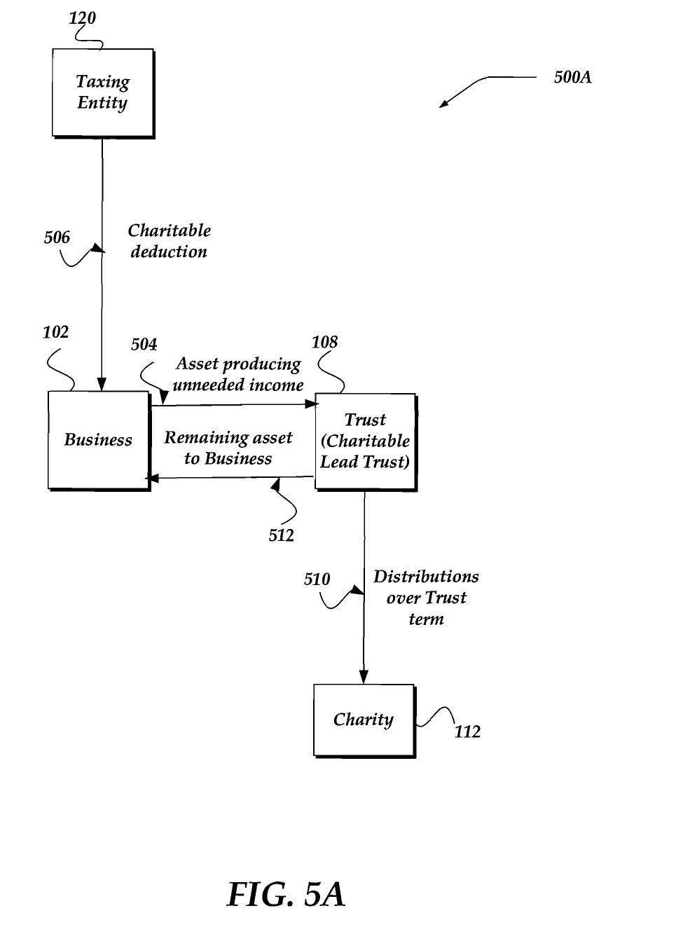

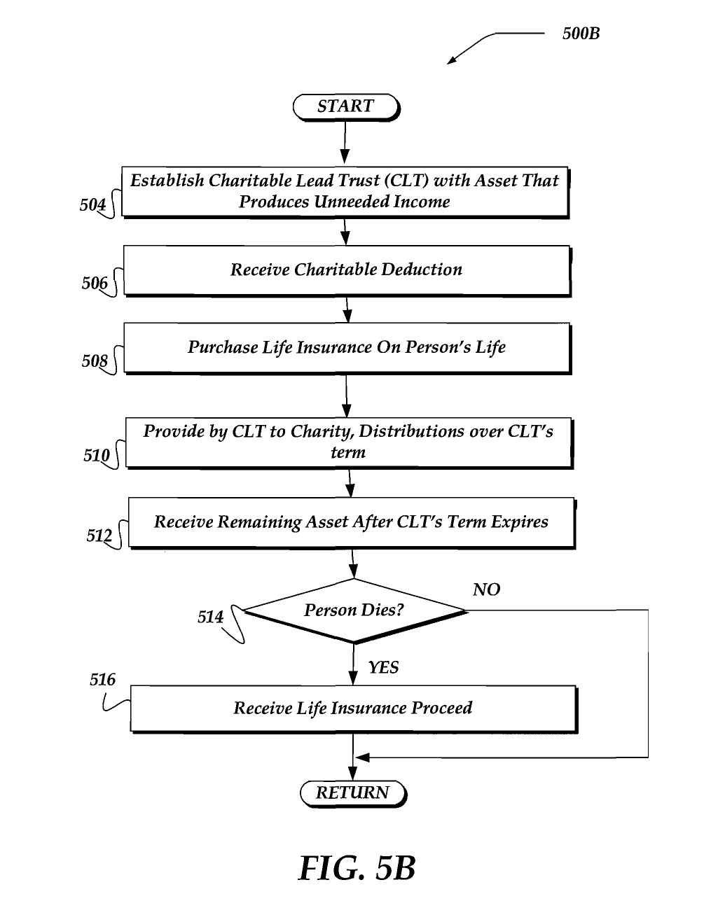

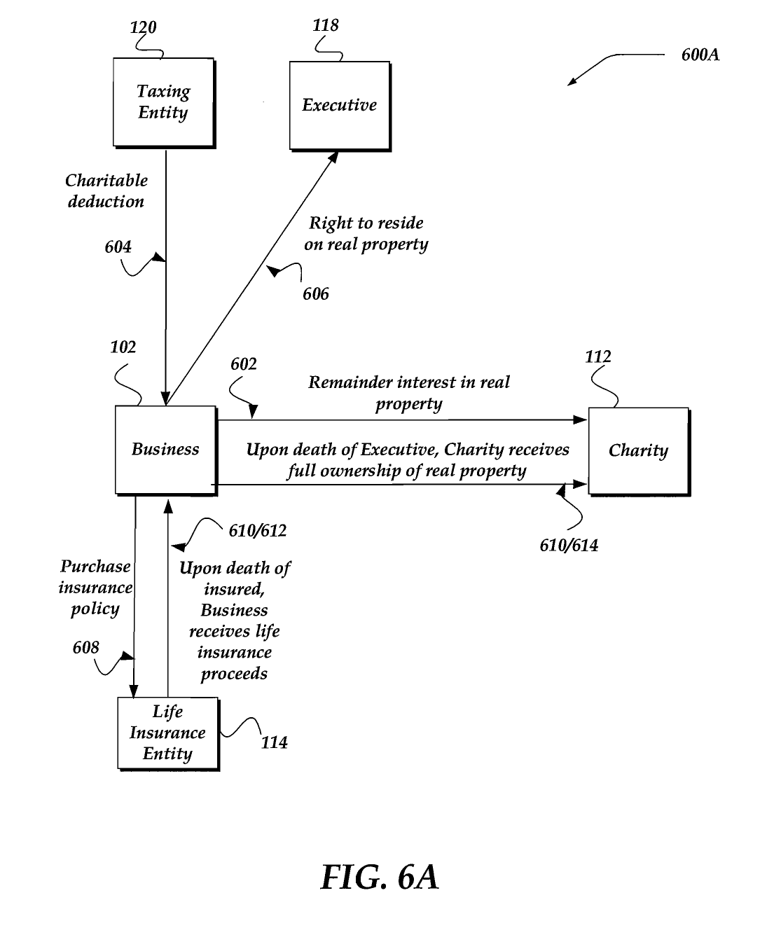

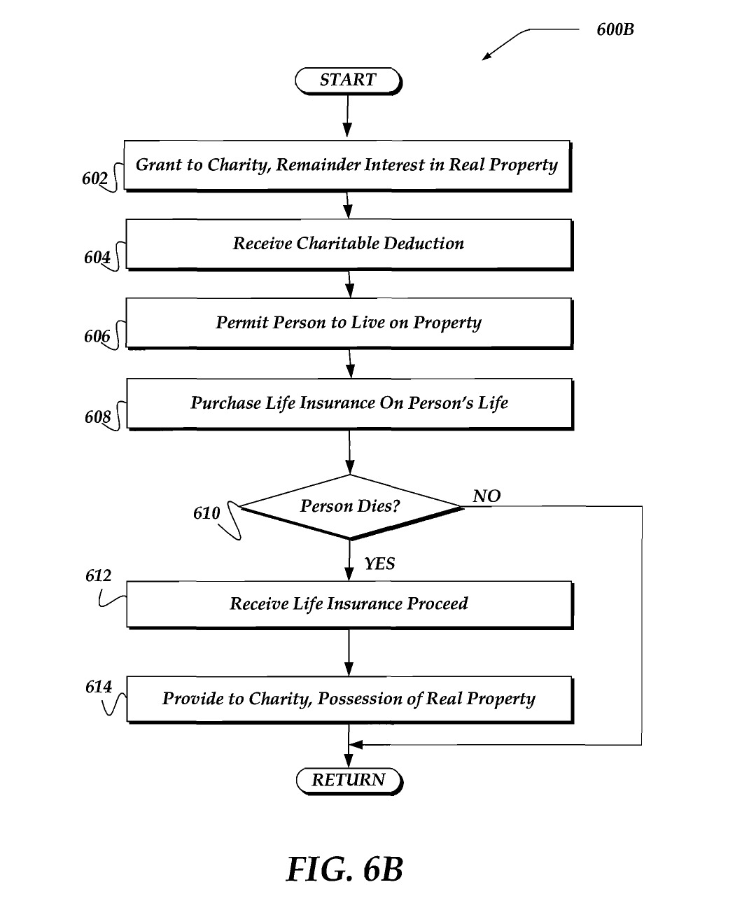

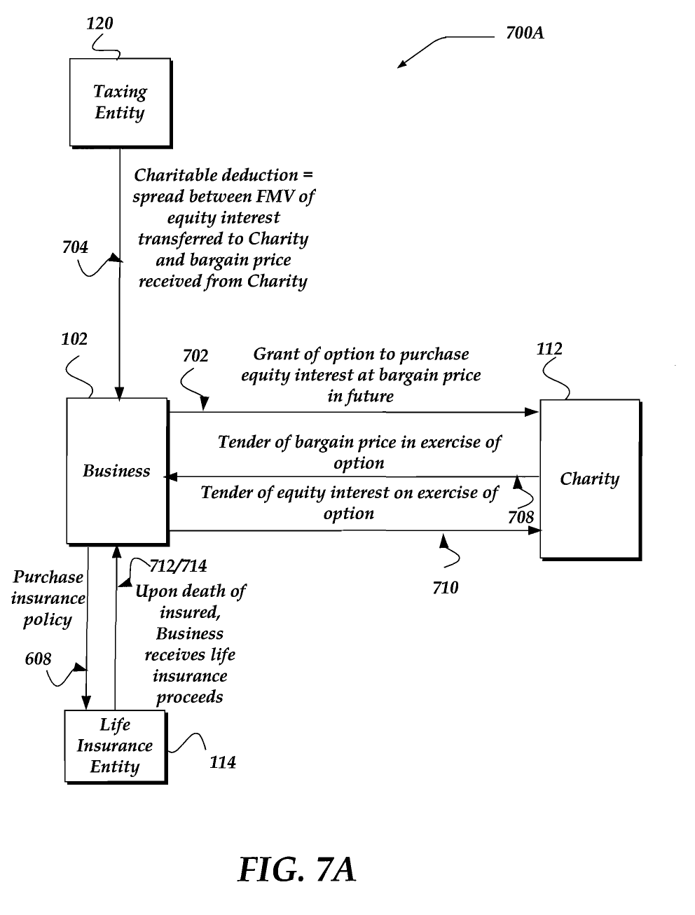

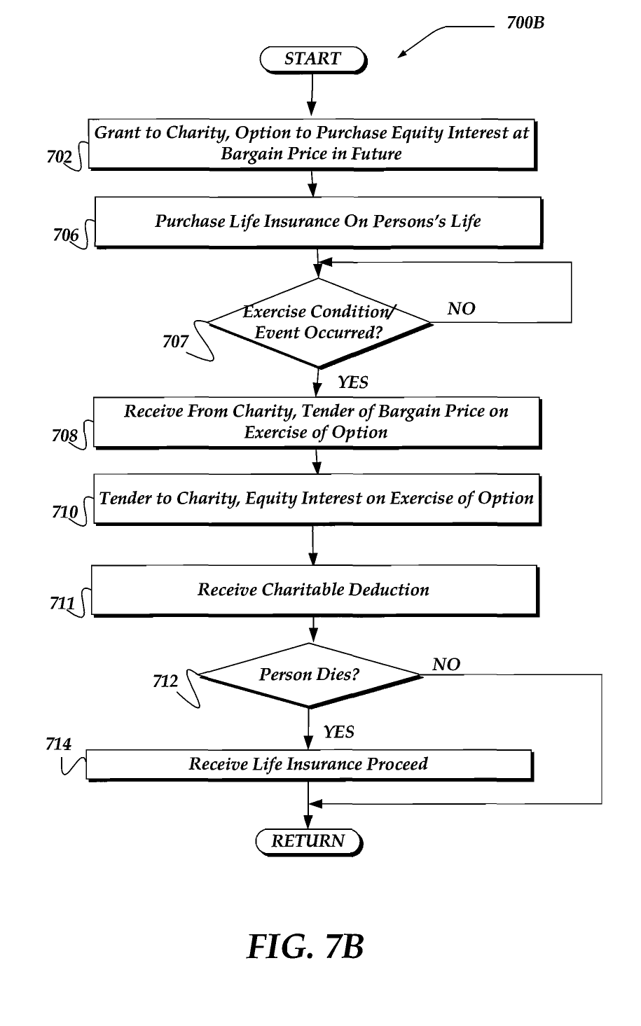

In an alternate embodiment, Business 102 may secure a private letter ruling (PLR) from the IRS prior to creating and/or funding Trust 108, or at any other stage of using the processes described herein (including process 100B of FIG. 1B, 200B of FIG. 2B, 300B of FIG. 3B, 400B of FIG. 4B, 500B of FIG. 5B, 600B of FIG. 6B, or 700B of FIG. 7B).

A. Illustrative Merger & Acquisition Trust Embodiments

In accordance with one embodiment of the invention, using a Merger and Acquisition (M&A) Trust, a merger or acquisition becomes dramatically more attractive for both Buyer 105 and Business 102 (seller). As early as feasible in the M&A process, ideally well before any contractual commitments are made, Business 102 transfers its stock assets (depending on whether a stock or asset sale is desired) to Trust 108 which acts as a Merger & Acquisition Trust. In this embodiment, Trust 108 qualifies as a Charitable Remainder Trust (CRT) under Section 664 of the Internal Revenue Code of 1986 and/or under Canadian IT-226R. This stock or asset transfer can consist of all or any portion of the stock or assets. Trust 108 provides that Business 102 is to receive a stream of distributions for a term of up to 20 years. At the end of Trust 108's term, whatever assets which remain in Trust 108 are to be distributed to Business 102's chosen charity, including Business 102's own charitable foundation (e.g., Charity 112). Business 102 is entitled to a charitable income tax deduction in the year it transfers the assets to Trust 108, even though no distribution to charity will occur for 20 years. The trustee of Trust 108 then enters into negotiations with prospective Buyer 105 (or Buyer 105's surrogate, etc.) for the sale of the stock or assets. When the sale has been consummated, Buyer 105 owns the stock or assets, and Business 102 and its owners recognize no current ordinary income or capital gain with regard to such sale. Moreover, Trust 108 pays no taxes on the sale, and neither does Business 102; however, Business 102 may be taxed, on the distributions it receives from the CRT.

If desired, Business 102 can go one step further and “make up” or compensate to itself or its owners the value of Trust 108 assets remaining at the end of 20 years, which are to be distributed to Business 102's selected charity. This “make up” is accomplished through a special life insurance policy on one or more corporate executives or owners, with the insurance proceeds to be paid to Business 102 or its designee or surrogate. The premiums on this policy can be paid in part, directly or indirectly, from the tax savings generated by Trust 108 or from other assets of Business 102.

If in some future year, Business 102 or its owners decided to do so, they could reach an agreement with Trustee 110 and Charity 112 to terminate Trust 108 prior to the expiration of Trust 108's term. At such time, Trust 108's assets would be divided and distributed to Business 102 or owners and Charity 112, in proportion to the values of their respective interests in Trust 108, and Trust 108 could be terminated, in whole or part. Similarly, if in some future year, Business 102 or its owners decided to do so, they could reach an agreement with Trustee 110 and Charity 112 to terminate Trust 108 prior to the expiration of Trust 108's term, by a contribution of Business 102's interest in Trust 108 to Charity 112, and this would usually generate an additional charitable deduction for Business 102 or its owners.

For example, assume that Business 102, a C Corporation, wants to make itself an attractive candidate for acquisition by another firm, and also wants to limit its tax exposure on a future acquisition. Business 102's basis in the assets it wishes to sell is $5,000,000, and the current fair market value of these assets is $50,000,000. If Business 102's stock were acquired in a traditional (conventional) M&A, Business 102 would realize ordinary income of $45,000,000, and would be liable for $15,750,000 in income taxes.

If instead, Business 102 were to transfer the assets, prior to any negotiations with prospective Buyer 105, to Trust 108 which acts as an M&A Trust, and Trust 108 later sold the assets, neither Trust 108 nor Business 102 would be liable for any ordinary income or capital gains tax on the transaction, yielding a savings of $15,750,000 in federal income tax (in addition to potential savings in state and local tax). The price to be paid for Business 102's assets could profitably be considerably lower than in a traditional (conventional) M&A, as there is no tax on the sale transaction, and in fact a tax benefit in the form of the charitable contribution is added. Business 102, or its successors or owners, would enjoy a distribution stream from Trust 108 for up to 20 years, and the charity (e.g., Charity 112) that Business 102 names as the beneficiary of Trust 108 will then receive all remaining assets of Trust 108.

If desired, Business 102 or its owners could “make up” or compensate for the assets ultimately passing to charity by using some portion of the overall savings to purchase life insurance policies from Insurance Entity 114. In addition, designated Charity 112 can perform good works in the community for years to come.

FIG. 2A illustrates one example of a process for managing a M&A Trust. As shown, at step 202, Business 102 establishes Trust 108 as an M&A Trust and funds Trust 108 with appreciated asset to be sold.

At step 204, for funding Trust 108, Business 102 or its owners are entitled to charitable contribution deduction for present value of remainder interest passing to Charity 112.

At step 210, Trust 108 sells asset to Buyer 105—e.g., a purchaser. No taxable gain is recognized by Trust 108 or Business 102 on this sale.

At step 212, Business 102 receives distributions from Trust 108 for up to 20 years, as determined (e.g. by Business 102) when establishing Trust 108; thereafter, Charity 112 receives all remaining Trust 108's assets.

At step 220/222, if Business 102 has insured lives of one or more executives, directors or employees, Business 102 receives life insurance proceeds on death of insured.

FIG. 2B illustrates one example of a logic flow for managing a M&A Trust. Process 200B of FIG. 2B begins at step 202, where Business 102 establishes Trust 108 as an M&A Trust. Trust 108 may be any form of CRT qualifying under Section 664, IT-226R, or the like. Business 102 also designates or empowers another party (e.g. a strawman) to designate Charity 112 as a remainderman to receive remaining assets from Trust 108. Business 102 designates itself or a third-party as a beneficiary of a recurring benefit of Trust 108. Business 102 also funds Trust 108 with asset to be sold.

In an alternate embodiment, at step 202, transferring the assets to Trust 108 comprises transferring (gifting or selling or otherwise) the assets to be sold to an intermediary individual, entity or group or groups of individuals and/or entities, who in turn establishes Trust 108—that is, the intermediary individual or entity sets up Trust 108 at the direction (express or tacit) of Business 102, or as surrogate for Business 102, or the like.

In an alternate embodiment, at step 202, where the sale (e.g., M&A) involves either an asset sale or a stock (or other form of equity) acquisition, or some hybrid of both, Business 102/Buyer 105 can delay transferring the assets/equity into Trust 108, until it is nearly certain the sale will happen, but before there is any binding commitment (written or oral) to sell the assets/equity such that Taxing Entity 120 (e.g., the IRS) would treat it as a prearranged sale. The sale can be determined to be nearly certain based on an amount of negotiations, an agreement in principle of at least some of the aspects of the sale, an amount of time and/or money spent in negotiating the deal, or the like, all in a manner fully consistent with applicable law and regulations.

In another embodiment, at step 202, the assets may be transferred into some other entity or trust container, before the other entity is transferred into Trust 108. For example, where the sale (e.g., M&A) involves an equity sale, an asset sale, or a hybrid asset/equity sale, then rather than transferring the equity (and/or assets) directly into Trust 108, a donor (e.g., Business 102) can instead transfer the equity directly or indirectly into a C corporation, taking back the stock in the C corporation in a tax-free Internal Revenue Code Section 351 exchange. Then, the donor transfers the C corporation stock into Trust 108. This use of the C corporation can prevent “unrelated business taxable income” (UBTI) to Trust 108, as an exception to such UBTI is recognized by the IRS if the Trust is receiving dividend income from a C corporation. In this way, if the acquisition is delayed for any reason, Trust 108 will not be found to be having income from the operation of an active trade or business (which, without the intervening C corporation, might well otherwise be the case).

In another embodiment, at step 202, where the sale (e.g., M&A) involves an asset sale, a hybrid, or solely equity sale, the seller (e.g., Business 102) transfers an option to Trust 108, under which, if the option vests (e.g., if the seller finds a buyer and is satisfied with the deal), then Trust 108 can exercise the option and acquire the assets at little or no cost from the seller business. “Vesting” events that may be used to “trigger” the Trust's ability to “exercise” the option may include the Seller/Business 102's signing a binding commitment to sell the assets; receiving an offer from a third party (i.e., Buyer 105 or its surrogate/strawman) to purchase the assets (or equity); receiving an offer from a third party (i.e., Buyer 105 or its surrogate/strawman) to purchase the assets (or equity) which seller accepts (or, in the alternative, finds acceptable or otherwise approves); or any other type of vesting event.

In this embodiment, Trust 108's exercise of the option may be “cashless”, in order to avoid a “sale” to Business 102 establishing Trust 108 (as such a sale may well be deemed to be an act of “self-dealing,” subject to excise tax under Section 4941 of the Code). That is, Trust 108 would not actually transfer any money or assets to Business 102 upon exercise of the Trust 108's option; instead, it would reduce the number of equity shares it would receive upon exercise, to “cover” the “exercise price.” In this embodiment, the IRS has ruled that such a cashless exercise does not create “self-dealing” problems.

In yet another embodiment, at step 202, donor Business 102 creates a C corporation to hold the assets to be acquired (and/or equity interests, and any sort of mixed hybrid combination of assets/equity), and transfers the assets/equity into the C corporation in a tax-free Code Section 351 exchange. Donor contributes the C corporation stock to the Trust. Donor then leases the assets/equity from the C corporation (owned by the Trust) so that the donor Business 102 can continue to operate as a business until the acquisition occurs. As Trust 108 is receiving dividend income from the C corporation, there should be no unrelated business taxable income (UBTI), and as the donor Business 102 is leasing from the C corporation instead of from Trust 108, there should be no taxable “self-dealing” problems.

In any case, at step 202, one or more assets of Business 102 are transferred to Trust 108, as allowed by current or future law, regulation, rulings, or the like.

Processing next continues to step 204, where, for funding Trust 108, Business 102 or its owners are entitled to a charitable contribution deduction for a value of the remainder interest passing to Charity 112. In another embodiment, at steps 202 and 204, Business 102 may contribute a partial interest in the stock or assets to be acquired, rather than the entire interest, to Trust 108, to achieve a partial tax savings.

Business 102 is entitled to a charitable deduction at the time Trust 108 is funded (i.e., a current deduction for the year of funding Trust 108, even though the charity/charities (e.g., Charity 112) will not receive any distribution as a remainderman until the termination of Trust 108's term ends). In one embodiment, the charitable deduction is based on the present value of the remainder interest in Trust 108, determined as provided under the Treasury Regulations. In the case of a C corporation, this deduction is taken on the C corporation's corporate return; in the case of pass-through entities such as an S corporation, this deduction passes through to be used on the returns of the owners, where it can offset other income as well as any income received from Business 102.

Processing next continues to step 208, where Business 102, or its surrogate/strawman or designee, buys an insurance policy for a life of at least one person (e.g. Executive 118) on whose life the Business 102 has an insurable interest, from Insurance Entity 114. Processing next continues to step 210.

At step 210, Trust 108 (through Trustee 110) sells the asset to Buyer 105 sale in furtherance of a business objective of Business 102. No current taxable gain is recognized by Trust 108 or Business 102 on this sale. Business 102 may (or may not) have had some preliminary discussions with Buyer 105 for the sale. Business 102 may suggest to Trustee 110 that Trustee 110 consider approaching Buyer 105, or may leave all such activities solely to Trustee 110. In one embodiment, Trustee 110 may be or include Business 102. Processing next continues to step 212.

At step 212, Business 102 receives distributions from Trust 108 for up to Trust 108's term (e.g., 20 years), as determined when establishing Trust 108. Processing next continues to step 216.

At step 216, Business 102 pays the premium for the insurance policy from at least a portion of distributions and/or any tax deductions, or any other source. Processing next continues to step 218.

At step 218, after Trust 108's term, Charity 112 receives a remaining asset of Trust 108 (e.g. after distributions of any remaining funds owed to other beneficiaries or creditors). Processing next continues to decision step 220.

At decision step 220, it is determined whether a person whose life is insured under the life insurance policy has died. If the person has died, then processing continues to step 222. Otherwise, processing continues to other steps. In one embodiment, where the insurance policy covers the lives of more than one persons, if it is determined that one of the person has died, then only the portion covering that person will be payable.

At step 222, if Business 102 has insured lives of one or more persons, directors, and/or employees by buying an insurance policy from Insurance Entity 114, Business 102 (or any other party designated by Business 102) receives life insurance proceeds on the death of the insured (e.g. immediately, or spread over a term of years, or the like). Processing then continues to other steps.

At least in some embodiments, securing the insurance policy(ies) may be optional. Thus, in these embodiments, steps 208, 216, 220 and 222, may not be performed.

The reader will appreciate that the M&A Trust using a CRT provides particular qualities and advantages suitable to proceeding with the business objective of completing an M&A. Some of the advantages include: the CRT is a tool created by Congress and fully recognized by the Internal Revenue Service as well as the Canadian tax authorities; the CRT affords the business the ability to designate a Trustee or co-Trustees if it wishes; the CRT affords the business the ability to designate the charitable remainderman, including its own charitable foundation, if it wishes; the CRT is a tax-exempt entity; funding of the CRT entitles the business to a charitable deduction; the CRT provides additional benefits to the business in the form of the regular distributions made to the business or its designee for the term of the CRT; the CRT affords the business with the flexibility of selecting the most beneficial combination of trust term, up to 20 years, and form and mode of payment of distributions, whether through a CRUT, of any of four major varieties, or a CRAT, or a multi-CRT'd combination; the sale of the business's asset(s) or equity to the acquiring firm by the CRT Trustee is not a taxable transaction, either to the CRT or to either of the businesses; the savings of tax on the sale of the asset(s) considerably increases the CRT's corpus, which in turn permits maximization of the size and nature of distributions to the business and to the charitable remainderman; income and gain from the sale and reinvestment of CRT assets generates to tax to the CRT and no immediate tax to the business; the CRT assets enjoy protection from creditors of the business; the business enjoys the flexibility in using the CRT to permit the CRT to run its full term, or to terminate the CRT “early,” in whole or part, with the approval of the charitable remainderman and Trustee, either by dividing and distributing the CRT corpus proportionately to the business and the charitable remainderman or by a contribution by the business of all or a portion of its beneficial interest to the charitable remainderman or another charity or charities; the beneficial interests in the CRT of the business and the charitable remainderman can serve as collateral for a loan to the business and/or to the charitable remainderman, to permit immediate tax-free use of the funds; and/or the CRT permits the business with opportunities for favorable publicity as a good corporate citizen, and enhanced goodwill and reputation in the community as a result of its commitment to charity.

Accordingly, the reader will see that at least some embodiments of the invention provide the mechanism for a business merger or acquisition with no immediate tax consequences for Business 102 or Trust 108, and also the mechanism for Business 102 to provide funding to Charity 112, thus enhancing its community goodwill and favorable publicity, as well as, optionally, the means to make up for the value of assets distributed to charity at the end of Trust 108's term via life insurance.

B. Illustrative Business Asset Sale Trust Embodiments

In accordance with one embodiment of the invention, Business 102 can use a Business Asset Sale Trust (“BAST”) to utilize pre-tax dollars instead of post-tax dollars to fund Business 102's desired charitable contributions. Simply stated, the BAST can be utilized in any setting in which Business 102 is contemplating the sale or liquidation of an asset or a group of assets. There is virtually no limit to the sorts of assets that Business 102 might be selling, and these can consist of: land; improved realty; a division; inventory; stock in trade; equity interests (including stock) in other businesses; treasury shares or other stock in the selling business itself, or in an affiliated entity; options; investment assets; goodwill; bonds; collectibles; papers; records; journals; software equipment; computers; office furniture; business supplies; bank owned life insurance (BOLI); corporate owned life insurance (COLI); etc. BAST can be used for a partial undivided interest in an asset, for all of Business 102's interest in the asset, for more than one asset, for a grouping of assets, etc.—all possible asset configurations and interests. As such, the M&A Trust embodiment, described above, may be seen as a subset or special application of the BAST embodiment.

In one embodiment, Business 102 can sell the asset with no tax liability. Instead of selling the asset directly, Business 102 transfers the asset to the Trust 108 which acts as a BAST. In this embodiment, Trust 108 qualifies as a Charitable Remainder Trust (CRT) under Section 664 of the Internal Revenue Code of 1986 and/or under Canadian IT-226R. Trust 108 calls for Business 102 to receive a stream of distributions for a term of up to 20 years, after which any remaining trust assets will be distributed to Business 102's preferred Charity 112, for example Business 102's own charitable foundation. Trust 108 then sells the asset, and, as Trust 108 is an income tax-exempt entity, no tax is owed on the sale. In addition, Business 102 is entitled to a charitable income tax deduction in the year it transfers the asset to Trust 108, even though no distribution to charity will occur for up to 20 years. Charity 112 can use the funds it receives to carry on good works in the name of Business 102, further enhancing Business 102's community goodwill and favorable publicity.

For example, assume that Business 102, a C Corporation, has been holding onto a highly appreciated parcel of land which it would long since have sold, but for its reluctance to incur the large tax liability which it would create for itself upon the sale. Business 102's cost basis in the land is $2,000,000, and the land is now valued at $50,000,000.

If Business 102 sold the land without utilizing a Business Asset Sale Trust it would generate a tax liability of $16,800,000.

If instead, Business 102 utilizes a Business Asset Sale Trust, it would incur no tax liability on the sale by Trust 108 of the land, translating into a savings of $16,800,000 for Business 102, not including savings in state and local tax in those jurisdictions in which such tax would be imposed on a sale of the asset by Business 102 outside of a Business Asset Sale Trust.

Business 102 would also create a charitable income tax deduction for itself when it transfers the land to Trust 108, based on the current value of the charitable interest in Trust 108.

Trust 108 provides that, for 20 years, Business 102 will receive quarterly (or more frequent, if desired) distributions from Trust 108. Trust 108 provides further that, at the end of the 20-year period, any remaining Trust assets which have not been distributed to Business 102 will be distributed to Business 102's own charitable foundation, for use in creating community goodwill through charitable projects in the community, on behalf of Business 102.

If desired, Business 102 can go one step further and “make up” or compensate to itself the value of Trust 108's assets remaining at the end of the term of years, which are to be distributed to Business 102's selected charity. This “make up” is accomplished through one or more life insurance policies (e.g., purchased from Insurance Entity 114) on one or more corporate executives, directors, and/or employees, with the insurance proceeds to be paid to Business 102 or its designee or surrogate/strawman. The premiums on this low-cost policy can be paid from the tax savings generated by Trust 108.

FIG. 3A illustrates one example of a process for managing a Business Asset Sales Trust. As shown, at step 302, Business 102 establishes Trust 108 as a Business Asset Sale Trust and funds Trust 108 with appreciated asset to be sold.

At step 304, for funding Trust 108, Business 102 or its owners are entitled to charitable contribution deduction for value of remainder interest passing to Charity 112. In another embodiment, Business 102 may contribute a partial interest in the appreciated asset, rather than the entire interest, to Trust 108, to achieve a partial tax savings.

At step 310, Trust sells asset to Buyer 105. No currently taxable gain is recognized by Trust 108 or Business 102 on this sale.

At step 312, Business 102 receives distributions from Trust 108 for up to 20 years, as determined (e.g. by Business 102) when establishing Trust 108; thereafter, at step 318, Charity 112 receives all remaining Trust 108's assets.

At step 320/322, if Business 102 has insured lives of one or more executives, directors, and/or employees, Business 102 receives life insurance proceeds on death of insured.

FIG. 3B illustrates one example of a logic flow for managing a Business Asset Sales Trust. Process 300B of FIG. 3B corresponds substantially to process 200B of FIG. B described above. For example, steps 302, 304, 308, 310, 312, 316, 318, 320, and 322 of FIG. 3 corresponds at least in part to steps 202, 204, 208, 210, 212, 216, 218, 220, and 222 of FIG. 2, respectively. One difference between processes 300B and 200B is that in process 300B, at step 302, Business 102 establishes Trust 108 as a Business Asset Sale Trust. As such, Trust 108 may be configured to sell virtually any asset. The sale may be, but need not be, related to an M&A. In process 300B, Trust 108 may be any form of CRT qualifying under Code Section 664, IT-226R, or the like. Business 102 also designates or empowers another party (e.g. a strawman) to designate Charity 112 as a remainderman to receive remaining assets from Trust 108. Business 102 designates itself or a third-party as a beneficiary of a recurring benefit of Trust 108. Business 102 also funds Trust 108 with asset to be sold.

Processing next continues to step 304, where, for funding Trust 108, Business 102 or its owners are entitled to charitable contribution deduction for present value of remainder interest passing to Charity 112. In another embodiment, at steps 302 and 304, Business 102 may contribute a partial interest in the stock or assets to be acquired, rather than the entire interest, to Trust 108, to achieve a partial tax savings. Processing next continues to step 308.

At step 308, Business 102 buys an insurance policy for a life of at least one person (e.g. Executive 118) on whose life Business 102 has an insurable interest, from Insurance Entity 114. Processing next continues to step 310.

At step 310, Trust 108 (through Trustee 110) sells the asset to Buyer 105 sale in furtherance of a business objective of Business 102. No current taxable gain is recognized by Trust 108 or Business 102 on this sale. Business 102 may have had some preliminary discussions with Buyer 105 for the sale. Business 102 may suggest to Trustee 110 that Trustee 110 consider approaching Buyer 105, or may leave all such activities solely to Trustee 110. In one embodiment, Trustee 110 may be or include Business 102. Processing next continues to step 312.

At step 312, Business 102 receives distributions from Trust 108 for up to Trust 108's term (e.g., 20 years), as determined when establishing Trust 108. Processing next continues to step 316.

At step 316, Business 102 pays the premium for the insurance policy from at least a portion of distributions and/or any tax deductions, or any other source. Processing next continues to step 318.

At step 318, after Trust 108's term, Charity 112 receives a remaining asset of Trust 108 (e.g. after distributions of any remaining finds owed to other beneficiaries or creditors). Processing next continues to decision step 320.

At decision step 320, it is determined whether a person whose life is insured under the life insurance policy has died. If the person has died, then processing continues to step 322. Otherwise, processing continues to other steps.

At step 322, if Business 102 has insured lives of one or more persons, directors, and/or employees by buying an insurance policy from Insurance Entity 114, Business 102 (or any other party designated by Business 102) receives life insurance proceeds on the death of the insured (e.g. immediately, or spread over a term of years, or the like). Processing then continues to other steps.

At least in some embodiments, securing the insurance polices may be optional. Thus, in these embodiments, steps 308, 316, 320 and 322, may not be performed.

The reader will appreciate that the BAST using a CRT provides particular qualities and advantages suitable to proceeding with the business objective of completing an asset sale. Some of the advantages include: the CRT is a tool created by Congress and fully recognized by the Internal Revenue Service as well as the Canadian tax authorities; the CRT affords the business the ability to designate a Trustee or co-Trustees if it wishes; the CRT affords the business the ability to designate the charitable remainderman, including its own charitable foundation, if it wishes; the CRT is a tax-exempt entity; funding of the CRT entitles the business to a charitable deduction; the CRT provides additional benefits to the business in the form of the regular distributions made to the business or its designee for the term of the CRT; the CRT affords the business with the flexibility of selecting the most beneficial combination of trust term, up to 20 years, and form and mode of payment of distributions, whether through a CRUT, of any of four major varieties, or a CRAT, or a multi-CRT'd combination; the sale of the asset(s) by the CRT Trustee is not a taxable transaction, either to the CRT or to the business; the savings of tax on the sale of the asset(s) considerably increases the CRT's corpus, which in turn permits maximization of the size and nature of distributions to the business and to the charitable remainderman; income and gain from the sale and reinvestment of CRT assets generates to tax to the CRT and no immediate tax to the business; the CRT assets enjoy protection from creditors of the business; the business enjoys the flexibility in using the CRT to permit the CRT to run its full term, or to terminate the CRT “early,” in whole or part, with the approval of the charitable remainderman and Trustee, either by dividing and distributing the CRT corpus proportionately to the business and the charitable remainderman or by a contribution by the business of all or a portion of its beneficial interest to the charitable remainderman or another charity or charities; the beneficial interests in the CRT of the business and the charitable remainderman can serve as collateral for a loan to the business and/or to the charitable remainderman, to permit immediate tax-free use of the funds; and/or the CRT permits the business with opportunities for favorable publicity as a good corporate citizen, and enhanced goodwill and reputation in the community as a result of its commitment to charity;

Accordingly, the reader will see that at least some embodiments of the invention provide the mechanism for the sale of an appreciated asset with no immediate tax consequences for Business 102 or the Business Asset Sale Trust (Trust 108), and also the mechanism for Business 102 to provide funding to Charity 112, thus enhancing its community goodwill and favorable publicity, as well as the means to make up for the value of assets distributed to Charity 112 at the end of Trust 108 term via life insurance purchased from Insurance Entity 114, for example.

C. Illustrative Business Liability Funding Trust Embodiments

In accordance with one embodiment of the invention, to shield assets from creditors and to fund a business liability, Business 102 may establish Trust 108 as a Business Liability Funding (BLF) Trust. In this embodiment, Trust 108 qualifies as a Charitable Remainder Trust (CRT) under Section 664 of the Internal Revenue Code of 1986 and/or under Canadian IT-226R. A Business Executive Compensation (BEC) Trust is a type of BLF Trust, where the funded business liability is a compensation for an employee of Business 102 (e.g., Executive 118).

Business 102 can choose to fund (in whole or part), via a BLF Trust, virtually any liability, commitment, pledge, or the like, of Business 102, of its affiliate or subsidiary or division. The liabilities may include: retirement compensation; retirement plan funding; installment sale obligations; compensation of third parties, including (without limitation) independent contractors, suppliers, covertures, consultants, etc.; director compensation; golden handcuffs (executive and employee incentives); golden parachutes (incentives to retire or leave the firm); life insurance premiums; litigation settlements or court-ordered payments; advertising; charitable giving; funding a new division, new product line, new headquarters, etc.; and any other obligation (whether or not actually mandatory as opposed to discretionary or merely desired) which the business or any of its affiliates or sub-entities faces or incurs.

Accordingly, in one embodiment, Business 102 can fund the compensation of its executives and other employees in a way which helps protect the funds from creditors of Business 102 and which helps charity in Business 102's name. Instead of funding the compensation directly, Business 102 creates Trust 108 as an Executive Compensation Trust. In this embodiment, Trust 108 qualifies as a Charitable Remainder Trust (CRT) under Section 664 of the Internal Revenue Code of 1986 and/or under Canadian IT-226R. Trust 108 calls for Business 102 or its designated executives or other employees to receive an income stream for a term of up to 20 years, after which any remaining trust assets will be distributed to Business 102's preferred charity, for example Business 102's own charitable foundation (e.g., Charity 112). Trust 108 can be funded with highly appreciated business assets transferred to Trust 108, which Trust 108 can then sell, and, as Trust 108 is an income tax-exempt entity, no current tax is owed on the sale by either Trust 108 or Business 102. In addition, Business 102 is entitled to a charitable income tax deduction in the year it transfers the asset to Trust 108, even though no transfer to charity will occur for up to 20 years. Charity 112 can use the funds it receives to carry on good works in the name of Business 102, further enhancing Business 102's community goodwill and favorable publicity.

For example, assume that Business 102 wishes to provide an advance, tax-favored and economical compensation stream for its key executive. Business 102 has been holding onto a highly appreciated parcel of land which it would long since have sold, but for its reluctance to incur the large tax liability which it would create for itself upon the sale.

Business 102's cost basis in the land is $2,000,000, and the land is now valued at $50,000,000.

If Business 102 sold the land without utilizing a Business Executive Compensation Trust, it would generate a tax liability of $16,800,000.

If instead, Business 102 utilizes a Business Executive Compensation Trust, it would incur no tax liability on the sale by Trust 108 of the land, translating into a savings of $16,800,000 for Business 102.

Business 102 would also create a charitable income tax deduction for itself when it transfers the land to Trust 108, based on the current value of the charitable interest in Trust 108.

Trust 108 provides that, for 20 years, Executive 118 (or Business 102, or its designee or surrogate/strawman) will receive quarterly (or more frequent, if desired) distributions from Trust 108. Trust 108 also provides that, if Executive 118 should leave the firm's employ for any reason during the 20-year term, the income stream from Trust 108 would instead be paid to another key executive, or back to corporation a itself. Trust 108 provides further that, at the end of the 20-year period, any remaining assets of Trust 108 which have not been distributed to Business 102, will be distributed to Business 102's own charitable foundation (e.g., Charity 112), for use in creating community goodwill through charitable projects in the community, on behalf of Business 102.

If desired, Business 102 can go one step further and “make up” or compensate to itself the value of Trust 108's assets remaining at the end of the term of years, which are to be distributed to Business 102's selected charity. This “make up” is accomplished through one or more life insurance policies on one or more corporate executives, directors, and/or employees, with the insurance proceeds to be paid to Business 102 or its designee or surrogate/strawman. The premiums on this low-cost policy can be paid from the tax savings generated by Trust 108.

FIG. 4A illustrates one example of a process for managing a Business Executive Compensation Trust. As shown, at step 402, Business 102 establishes Trust 108 as a Business Asset Sale Trust and funds Trust 108 with appreciated asset to be sold. At step 404, for funding Trust 108, Business 102 or its owners are entitled to charitable contribution deduction for value of remainder interest passing to Charity 112.

At step 410, Trust 108 sells asset to Buyer 105. No current taxable gain is recognized by Trust or Business 102 on this sale.

At step 412, Business 102 receives distributions from Trust 108 for up to 20 years, as determined when establishing Trust 108; thereafter, at step 418, Charity 112 receives all remaining assets of Trust 108.

At step 406, Business 102 designates specified executive or executives, directors, or other employees, or in the alternative, itself or its designee or surrogate/strawman, as the recipients of the distributions from Trust 108 for the term of employment. At step 414, the specified employee receives the distribution. In one embodiment, Business 102 may use Trust 108 to provide for retirement compensation for its executives or employees, providing such retirees with the enhanced security of creditor-protected principal.

At step 420/422, if Business 102 has insured lives of one or more executives, Business 102 receives life insurance proceeds on death of insured.

FIG. 4B illustrates one example of a logic flow for managing a Business Executive Compensation Trust. Process 400B of FIG. 4B corresponds substantially to process 200B of FIG. B described above. For example, steps 402, 404, 408, 410, 412, 416, 418, 420, and 422 of FIG. 4 corresponds at least in part to steps 202, 204, 208, 210, 212, 216, 218, 220, and 222 of FIG. 2, respectively. The difference between process 400B and 200B is that in process 400B, at step 402, Business 102 establishes Trust 108 as a Business Liability Funding (BLF) Trust. Trust 108 may be any form of CRT qualifying under Section 664, IT-226R, or the like. Business 102 also designates or empowers another party (e.g. a strawman) to designate Charity 112 as a remainderman to receive remaining assets from Trust 108. Business 102 designates itself or a third-party as a beneficiary of a recurring benefit of Trust 108. Business 102 also funds Trust 108 with asset.

In one embodiment, Trust 108 need not (but can) be funded with one or more assets the business wishes to sell. Hence, Trust 108 can be funded with assets that Business 102 does not wish Trustee 110 to sell, or with assets Business 102 wishes to have sold, or any combination, with some funded assets to be sold, some to be retained, some that may be sold or not, or the like. Processing next continues to step 404, where, for funding Trust 108, Business 102 or its owners are entitled to charitable contribution deduction for a value of remainder interest passing to Charity 112. In another embodiment, at steps 402 and 404, Business 102 may contribute a partial interest in the stock or assets to be acquired, rather than the entire interest, to Trust 108, to achieve a partial tax savings. Processing next continues to step 406.

At step 406, Business 102 may designate a third-party to which the business liability is owed as a beneficiary of at least a portion of the recurring distributions from Trust 108. In one embodiment, the third-party may be Executive 118, and the liability may be an executive compensation for Executive 118. In another embodiment, the third-party may be Buyer 105, or any other entity. In one embodiment, Business 102 may designate itself as the beneficiary. In one embodiment, Business 102 may be the only beneficiary of the recurring benefits of Trust 108.

In an alternate embodiment (not shown), after designating the third-party as an income beneficiary, at step 406, Business 102 can switch an application of the income stream to some other use—e.g., funding any other recurring (or nonrecurring) liability.

Processing next continues to block 408, where Business 102, or its surrogate/strawman or designee, buys an insurance policy for a life of at least one person (e.g. Executive 118) for whom the Business 102 has an insurable interest, from Insurance Entity 114 where Business 102, or its surrogate/strawman or designee, buys an insurance policy. Processing next continues to step 410.

At step 410, Trust 108 (through Trustee 110) sells the asset to Buyer 105 sale in furtherance of a business objective of Business 102. No current taxable gain is recognized by Trust 108 or Business 102 on this sale. Business 102 may have had some preliminary discussions with Buyer 105 for the sale. Business 102 may suggest to Trustee 110 that Trustee 110 consider approaching Buyer 105, or may leave all such activities solely to Trustee 110. In one embodiment, Trustee 110 may be or include Business 102. Processing next continues to step 412.

At step 412, Business 102 receives distributions from Trust 108 for up to Trust 108's term (e.g., 20 years), as determined when establishing Trust 108. Processing next continues to step 414.

At step 414, the third-party receives at least a portion of the distributions from Trust 108. In one embodiment, the third-party may receive all the distributions from Trust 108, in which case step 412 is not performed.

In another embodiment, Trust 108 pays its income stream to an entity other than the third-party (e.g., Executive 118 being compensated). For example, the income stream may go to Business 102 itself, or to a subsidiary or affiliate, or the like. The entity may, in turn, compensate Executive 118. Trust 109 may be configured to pay its income to someone other than the third-party (e.g., Executive 118) because there can be negative tax consequences for payments from Trust 108 directly to an employee or executive.

Processing next continues to step 416, where Business 102 pays the premium for the insurance policy from at least a portion of distributions and/or any tax deductions, or any other source. Processing next continues to step 418.

At step 418, after Trust 108's term, Charity 112 receives a remaining asset of Trust 108 (e.g. after distributions of any remaining funds owed to other beneficiaries or creditors). Processing next continues to decision step 420.

At decision step 420, it is determined whether a person whose life is insured under the life insurance policy has died. If the person has died, then processing continues to step 422. Otherwise, processing continues to other steps.

At step 422, if Business 102 has insured lives of one or more persons, directors, and/or employees by buying an insurance policy from Insurance Entity 114, Business 102 (or any other party designated by Business 102) receives life insurance proceeds on the death of the insured (e.g. immediately, or spread over a term of years, or the like). Processing then continues to other steps.

At least in some embodiments, managing the insurance polices may be optional. Thus, in these embodiments, steps 408, 416, 420 and 422, may not be performed.

The reader will appreciate that the BLF using a CRT provides particular qualities and advantages suitable to proceeding with the business objective of satisfying a business liability. Some of the advantages include: the CRT is a tool created by Congress and fully recognized by the Internal Revenue Service as well as the Canadian tax authorities; the CRT affords the business the ability to designate a Trustee or co-Trustees if it wishes; the CRT affords the business the ability to designate the charitable remainderman, including its own charitable foundation, if it wishes; the CRT is a tax-exempt entity; funding of the CRT entitles the business to a charitable deduction; the CRT provides additional benefits to the business in the form of the regular distributions made to the business or its designee for the term of the CRT; the CRT affords the business a dependable, predictable, and flexible cash flow which it can use in whole or part, or in combination with other business funds, to service its liabilities, whether these consist of executive compensation, retirement funding, other retirement payments, purchases, service contracts, etc.; the CRT affords the business with the flexibility of selecting the most beneficial combination of trust term, up to 20 years, and form and mode of payment of distributions, whether through a CRUT, of any of four major varieties, or a CRAT, or a multi-CRT'd combination; the sale of any asset(s) by the CRT Trustee is not a taxable transaction, either to the CRT or to the business; the savings of tax on the sale of the asset(s) considerably increases the CRT's corpus, which in turn permits maximization of the size and nature of distributions to the business and to the charitable remainderman; income and gain from the sale and reinvestment of CRT assets generates to tax to the CRT and no immediate tax to the business; the CRT assets enjoy protection from creditors of the business; the business enjoys the flexibility in using the CRT to permit the CRT to run its full term, or to terminate the CRT “early,” in whole or part, with the approval of the charitable remainderman and Trustee, either by dividing and distributing the CRT corpus proportionately to the business and the charitable remainderman or by a contribution by the business of all or a portion of its beneficial interest to the charitable remainderman or another charity or charities; the beneficial interests in the CRT of the business and the charitable remainderman can serve as collateral for a loan to the business and/or to the charitable remainderman, to permit immediate tax-free use of the funds; and/or the CRT permits the business with opportunities for favorable publicity as a good corporate citizen, and enhanced goodwill and reputation in the community as a result of its commitment to charity.

Accordingly, the reader will see that at least some embodiments of the invention provides the mechanism for the provision of compensation for executives or other employees in a manner which enjoys some protection from the creditors of Business 102, while also providing funding to Charity 112, thus enhancing its community goodwill and favorable publicity, as well as the means to make up for the value of assets distributed to charity at the end of Trust 108 term via life insurance.

D. Illustrative Business Income-Shifting Trust Embodiments

In accordance with one embodiment of the invention, Business 102 transfers an asset producing an unwanted income to a Trust 108, which acts as a Business Income-Shifting Trust. In this embodiment, Trust 108 qualifies as a charitable lead trust under the Internal Revenue Code, and which pays income to a designated charity or charities for a set term of years. Charity 112 can be Business 102's own charitable foundation, which can use the income to perform high-visibility good works in the community in the name of Business 102. After the set number of years has expired, Trust 108 assets return to Business 102. Business 102 creates goodwill and favorable publicity through its gift to Trust 108, and also provides a convenient method of funding its own business foundation. In some circumstances, a charitable deduction is even available to Business 102 for this contribution.

For example, assume that Business 102, a C corporation, owns a rental building which is generating income and adding to the corporation's tax liability. In eight years, Business 102's cash-flow is expected to be such that the rental income will be more welcome, and will not negatively add to Business 102's tax burden. Business 102 transfers the building, or a percentage interest in the building, to a Trust 108, a Business Income-Shifting Trust, for a term of eight years. During these eight years, the income from the building is paid to Business 102's charitable foundation (e.g., Charity 112), where it is used to carry on community good works in the name of Business 102. The local press frequently covers the awards and grants made on behalf of Business 102 by Charity 112. At the end of the eight years, the building returns to Business 102, at a time when the income flow is welcome.

FIG. 5A illustrates one example of a process for managing a Business Income-Shifting Trust. As shown, at step 504, Business 102 transfers asset generating temporarily unwanted income to Trust 108.

At step 506, Business 102 receives a charitable deduction for transferring the asset, which it may use to the extent permitted by law. In another embodiment, Business 102 may contribute a partial interest in the asset producing the temporarily unwanted income, rather than the entire interest, to Trust 108, to achieve a partial tax savings.

At step 510, for set term of years, Trust 108 pays income stream to Charity 112.

At step 512, at end of set term of years, Trust 108 distributes asset back to Business 102.

FIG. 5B illustrates one example of a logic flow for managing a Business Income-Shifting Trust. Process 500B of FIG. 5B begins at step 504, where Business 102 establishes Trust 108 as a charitable lead trust. Trust 108 also funds Trust 108 with an asset of Business 102 that produces unneeded income. Business 102 also designates or empowers another party (e.g. a strawman) to designate Charity 112 as a beneficiary of a recurring benefit of Trust 108. Business 102 also remainderman to receive remaining assets from Trust 108. Business 102 also designates itself or a third-party as a remainderman of Trust 108. Processing next continues to step 506.

Business 102 may establish Trust 108 in at least two ways. Business 102 may establish Trust 108 as a charitable lead trust of at least two types: Grantor Business Income-Shifting Trust, Non-Grantor Business Income-Shifting Trust.

In an alternate embodiment, Business 102 can designate or empower another party to designate one or more charities (e.g., Charity 112) as the income beneficiaries, can set restrictions or limitations on the specific uses to be made by the charities of the distributions from Trust 108, or can make these available for the general unrestricted uses of the charity/ies, or some combination thereof.

At step 506, for funding Trust 108, Business 102 receives a charitable deduction. In the case where Trust 108 is a Grantor Business Income-Shifting Trust (a variety of Business Income-Shifting Trust in which Business 102 or its surrogate/strawman is treated as the grantor or owner of the Trust and hence is taxed on the income of the Trust), Business 102 enjoys a charitable income tax deduction for the year in which Trust 108 is established, based on the present value of the income interest given to charity. In this case, Business 102 would ordinarily be subject to income tax on the income of Trust 108 for the duration of Trust 108's term.

In one embodiment, step 506 may be optional and may not be performed. For example, in the case where Trust 108 is a Non-Grantor Business Income-Shifting Trust (a variety of Business Income-Shifting Trust in which Business 102 or its surrogate/strawman is not treated as the grantor or owner of the Trust and hence is not taxed on the income of the Trust), there is normally no charitable deduction for Business 102 for the year of creation of Trust 108. Instead, Trust 108 will generally be entitled to an income tax deduction for the contribution it makes to the designated charity/ies during Trust 108's term, which can offset the income, in whole or part, reducing taxes. Processing next continues to step 508.

At step 508, Business 102 buys an insurance policy for a life of at least one person (e.g. Executive 118) on whose life Business 102 has an insurable interest, from Insurance Entity 114. At step 508, a premium may also be paid for the life insurance policy. Processing next continues to step 510.

At step 510, Trust 108 (through Trustee 110) pays an income stream from the asset to Charity 112 over the term of Trust 108. Processing next continues to step 512.

At step 512, Business 102 receives the remaining asset from Trust 108. Processing next continues to decision step 514.

At decision step 514, it is determined whether the executive has died. If the executive has died, then processing continues to step 516. Otherwise, processing continues to other steps.

At step 516, if Business 102 has insured lives of one or more persons, directors, and/or employees by buying an insurance policy from Insurance Entity 114, Business 102 (or any other party designated by Business 102) receives life insurance proceeds on the death of the insured (e.g. immediately, or spread over a term of years, or the like). Processing then continues to other steps.

At least in some embodiments, managing the insurance polices may be optional. Thus, in these embodiments, steps 508, 514, and 516, may not be performed.

The reader will appreciate that the Business Income Shifting Trust using a CLT provides particular qualities and advantages suitable to proceeding with the business objective of satisfying a business liability. Some of the advantages include: the CLT is a predictable, flexible tool fully recognized by the IRS; the CLT uniquely permits the business to rid itself of an unwanted income stream for a period of years, and to retrieve that income stream at the end of the period; the CLT affords the business with the ability to select the charitable lead beneficiary or beneficiaries, including the business's own charitable foundation, if it desires; the CLT allows the business to fine-tune the CLT structure to provide the most advantageous; the CLT permits the business to select which variety of structure is most beneficial for its needs and goals as to the unwanted income stream, including the ability to choose between a “grantor” CLT structure, in which the business receives a charitable deduction in the year the CLT is created and funded, or a “nongrantor” CLT structure, in which the business is not taxed on the income earned by the CLT; the CLT format offers the business the choice between having the charitable lead beneficiary receive its interest as an annuity amount (as in a CLAT) or as a unitrust amount (as in a CLUT); the business may create multiple CLTs, with similar or quite different terms and provisions, as it deems best to most fully achieve its goals; and/or the CLT permits the business with opportunities for favorable publicity as a good corporate citizen, and enhanced goodwill and reputation in the community as a result of its commitment to charity.

Accordingly, the reader will see that at least some embodiments of the invention provides the mechanism for the temporary shift of unwanted income to Charity 112, and also the mechanism for Business 102 to provide funding to Charity 112, thus enhancing its community goodwill and favorable publicity.

E. Illustrative Executive Life Estate Plan Embodiments

In the individual planning context (i.e., outside the realm of business planning), it has long been recognized that an individual is entitled to a charitable deduction if he or she contributes a personal residence or farm to charity, retaining a life estate in such property. The charitable deduction is based on the present value of the remainder interest passing to charity at the death of the measuring life.

The Executive Life Estate Plan embodiment utilizes this “retained life estate” mechanism in the business realm, where it can help solve problems in a profitable way for the business. In the Executive Life Estate Plan embodiment, Business 102 retains a life estate in the personal residence or farm, measured by some individual person's life.

Thus, in one embodiment, Business 102 can provide its top executives and their families with a life estate in a personal residence or farm. Business 102 transfers its interest in the residence or farm to its selected charity, including Business 102's own charitable foundation, while retaining to itself a life estate in the residence or farm, based on the measuring life of the executive, or on any other life as a measuring life. The executive may continue to reside there for the remainder of his or her employment with Business 102, or for life or some shorter term, as determined by Business 102 or its surrogate/strawman, and upon his or her death, the residence or farm passes to the selected Charity 112. Charity 112 can use the home or land it receives to carry on good works in the name of Business 102, further enhancing Business 102's community goodwill and favorable publicity. If desired, Business 102 can go one step further and “make up” to itself the value of the remainder interest in the residence or farm, which is owned by Business 102's selected Charity 112. This “make up” is accomplished through one or more life insurance policies on one or more executives, directors, and/or employees, with the insurance proceeds to be paid to Business 102 or its designee. The premiums on this policy or policies can be paid from the tax savings generated by Trust 108.

For example, assume that Business 102, a C corporation, wishes to attract or retain the services of Executive 118 by providing a personal residence for Executive 118 and his family to occupy as part of the overall compensation package. Business 102 owns a house which is not otherwise needed for business purposes. The house is valued at $1 million, and Business 102's basis in the house is $100,000. If Business 102 sells the house, it will generate a tax on the $900,000 of appreciation, incurring a federal tax of 35%, or $315,000 (not including state and local taxes). Instead of selling the house, Business 102 conveys a remainder interest in the house to Charity 112, retaining a life estate, based on the life of its CEO or on some other measuring life, to itself. This conveyance creates a charitable deduction for Business 102. Executive 118 is invited to occupy the house as his family's personal residence for so long as Executive 118 remains with Business 102. As the house is not sold, Business 102 has not created any tax exposure. If Executive 118 leaves the employ of Business 102 for any reason, then Business 102 can terminate Executive 118's occupancy of the house, and either permit another executive to reside there, or can contribute the remaining portion of the life estate interest to the Charity 112 or another charity or charities, for an additional charitable income tax deduction.

FIG. 6A illustrates one example of a process for managing an Executive Life Estate Plan. As shown, at step 602, Business 102 transfers remainder interest in real property, including a personal residence or farm, to Charity 112, retaining to itself a life estate based on the life of the top executive (e.g., Executive 118). At step, 604, for this transfer, Business 102 or its owners are entitled to charitable contribution deduction for value of remainder interest passing to Charity 112.

At step 606, Business 102 offers executive right to reside on premises for life. In another embodiment, Business 102 may permit successive key executives to reside in the residence or farm, or may permit a retired executive, or a current or retired director, and his or her family to reside there.

At step 610/614, at death of Executive 118, Charity 112 receives ownership of residence or farm.

At step 610/612, if Business 102 has insured lives of one or more executives, Business 102 receives life insurance proceeds on death of insured.

FIG. 6B illustrates one example of a logic flow for managing an Executive Life Estate Plan in furtherance of a business objective of the business, wherein the business objective relates to an employment of the one or more persons. In one embodiment, the business objective be to provide an incentive to the one or more persons to leave an employ of Business 102. Process 600A of FIG. 6B begins at step 602, where Business 102 grants a remainder interest in a real property to Charity 112. The real property may be a personal residence, a farm, or the like. In one embodiment, Business 102 may reserve to Business 102 or another entity a life estate or a term of years estate in the real property. Processing next continues to step 604.

At step 604, Business 102 receives a charitable deduction for granting the remainder interest based on the present value of the remainder interest, which is available in the year the life estate (or term of years estate) plan is established, although some time will generally elapse before the charity or charities actually come into possession of the residence or farm property. In one embodiment, the remainder interest is a vested remainder interest Processing next continues to step 606.

At step 606, Business 102 permits a person (or one or more persons) relating to Business 102 to live on the real property in furtherance of the business objective. In this embodiment, person is someone (or some group of people) to whom Business 102 wishes to provide a benefit to, in the form of the right to live in a personal residence or farm supplied by Business 102 (either alone, with his or her family, with his or her significant other, etc.). The person includes an employee, executive, director, retiree, etc. The person need not be given the right to live in the residence or on the farm for his or her lifetime, but can be given this right if Business 102 wishes. The employee may be Executive 118.

In one embodiment, the remainder interest may be subject to a condition subsequent. For example, the deed or other instrument creating the remainder interest may provide that Charity 112 will cease to hold the property if it fails to meet certain conditions specified in the deed or other instrument.

The person may live on the real property until the person dies or until the person leaves the employment of Business 102. In this embodiment, the measuring life of the life estate is the life of the person. However, the particular executive, director, retiree, etc., need not be the measuring life.

Processing next continues to step 608, where Business 102, or its surrogate/strawman or designee, buys an insurance policy for a life of at least another person (e.g. Executive 118) on whose life Business 102 has an insurable interest, from Insurance Entity 114. While the person whose life has been insured is shown as the person who is permitted to live on the real property, this need not be the case, and the persons may be different people. At step 608, a premium may also be paid for the life insurance policy. Processing next continues to step 610.

At step 610, it is determined whether the person has died. If the person has died, then processing continues to step 612. Otherwise, processing continues to other steps.

At step 612, if Business 102 has insured the lives of one or more persons, directors, and/or employees by buying an insurance policy from Insurance Entity 114, Business 102 (or any other party designated by Business 102) receives life insurance proceeds on the death of the insured (e.g. immediately, or over a term of years, or the like). Processing next continues to step 614.

At step 614, at the death of the measuring life (e.g., the life of the employee or another person), the life estate ends and the full ownership of the property is transferred to the charity or charities (e.g., Charity 112) selected by Business 102 (or its designee or surrogate/strawman), which can include Business 102's own charitable foundation, in whole or part. The property can then be retained or sold, as the charity or charities may wish (or can be used as set forth in the conditions or terms of the plan as established by Business 102). Processing then continues to other steps.

At least in some embodiments, managing the insurance polices may be optional. Thus, in these embodiments, steps 608 and 612, may not be performed.

In an alternate embodiment, Business 102 can establish a term of years instead of a life estate for the real property. In this embodiment, at step 602, Business 102 grants a remainder interest to Charity 112 for a term of years. At step 610, it is determined whether the term of years has ended. If the term of years has ended, then processing continues to block 614, as described above.

In an alternate embodiment, Business 102 may transfer the residence or farm to a straw person or entity, or other surrogate/strawman or alter ego, who or which then performs steps 604-614 described above.

In an alternate embodiment, Business 102 transfers cash or assets to the employee for whom Business 102 desires the life estate/term of years estate, and in turn the employee performs steps 604-614 described above—e.g., the employee purchases a farm or residence and deeds the remainder interest to charity or charities, or leaves it in trust or via will for the charity or charities.

The reader will appreciate that the Executive Life Estate Plan using a retained life estate gift provides particular qualities and advantages suitable to proceeding with the business objective of attracting, rewarding, and/or incentivizing an executive, director, and/or a retiree with the Executive Life Estate Plan. Some of these advantages include: the Plan affords the business the ability to attract qualified executives and directors; the Plan offers the business the ability to retain talented executives and directors; the Plan permits the business to encourage and incentivize executives and/or directors to retire or depart the firm; the Plan permits the business to reward past service of retired executives and/or directors; the contribution of the remainder interest to charity creates an income tax deduction for the business; the income tax deduction afforded by the Plan is enjoyed in the taxable year in which the remainder interest is gifted to charity, although the charity does not come into possession of the residence or farm until a future year; the Plan permits the business to reward or incentivize a series of executives, directors and/or retirees during the measuring life or term of years; the Plan provides the business with opportunities to enhance its prestige and profile as a good business citizen which helps charity, and can provide the business with opportunities for favorable publicity.

Accordingly, the reader will see that at least some embodiments of the invention provides the mechanism for Business 102 to attract and retain the key executive, and also the mechanism for Business 102 to provide funding to Charity 112, thus enhancing its community goodwill and favorable publicity, as well as the means to make up for the value of assets distributed to Charity 112 at the end of Trust 108's term via life insurance.

F. Illustrative Business Charitable Equity Options for High-Income Years Embodiments

Charitable Equity Options rely on the general provisions relating to the charitable income tax deduction, Code Section 170. Charitable Equity Options are essentially in the nature of common law charitable pledges, which are not deductible by the business until the stock or other business equity interests are issued to the charity. The law permitting their use is to be found in a series of IRS rulings, including a Revenue Ruling, beginning in 1975 and from time to time (usually in the form of private letter rulings) since then.

Charitable Equity Options may be considered a form of “bargain sale” or “bargain purchase.” As used in the charitable giving arts and under the Code and Treasury Regulations, the term “bargain sale” includes a sale by a non-charity to a charity of an asset, at a purchase price less than the fair market value of the asset; in such a case, the seller is usually entitled to a charitable deduction for the difference between the asset's actual value and the amount the seller receives from the charity.

As used herein, the terms “option,” “option grant,” “pledge,” “option pledge,” “charitable option pledge,” and “charitable option grant,” refer to an agreement (which may be oral or in writing) or undertaking, or the like, by a business that, if certain conditions are met (including merely the passage of time), the holder of the “option” may “exercise” the option, either by providing to the business valuable consideration, including a sum of money, property, assets, or even a promissory note, or the like, or by a “cashless” exercise.

As used herein, the terms “issue”, “grant,” and “pledge” refers to an offer or expressed intention, whether written or not, under which a business or its surrogate/strawman is conveying a right or power to an option holder to receive equity interests at some future date if some specified condition or conditions are met.

The uses of Charitable Equity Options are potentially limitless to a business, such as Business 102. Uses include: pre-planning for a future high-income year; pre-planning for an IPO; pre-planning for a merger or acquisition; pre-planning for a reorganization; pre-planning for sale of an asset or division, etc.; pre-planning for a business expansion; pre-planning for future good publicity for charitable giving; ability to secure favorable recognition now about a gift not made until later, if at all; gives owners of privately held business the ability to “reach their control” forward to a time, after an IPO or acquisition, e.g., when they do not have such untrammeled power in the business as they do when utilizing the Charitable Equity Options tool.

Thus, in accordance with one embodiment of the invention, Business 102 can plan in advance for future high-income pears, by issuing Charitable Equity Options to its selected charity, including Business 102's own charitable foundation (e.g., Charity 112). Business 102 issues an option grant to Charity 112, under which Charity 112 is entitled to receive an equity interest in Business 102 for a bargain-sale price in a future year. In the option grant document, Business 102 establishes the amount which the charity is to pay for the equity interest (the “strike price”), which is set well below the current and anticipated fair market value of the equity interest, so there is a difference (a “spread”) between the fair market value of the equity interest and the price the charity is to pay for the equity interest. The option grant document also specifies when the charity will be entitled to exercise the option (the “triggering event”), as for example, in a year when Business 102's income reaches a specified amount. When the triggering event occurs, the charity may tender the strike price to Business 102 (including in a “cashless” exercise), and Business 102 transfers the equity interest to the Charity 112. Business 102 is entitled to a charitable deduction in the year of Charity 112's exercise of the option, equal to the difference, or spread, between the price paid by Charity 112, and the then fair market value of the equity interest. Business 102 can use this charitable deduction to offset income in the high-income year.

If desired, Business 102 can “make up” or restore or compensate to itself the value of the equity interest received by Business 102's selected Charity 112. This “make up” or compensation is accomplished through one or more life insurance policies (or similar investments) on one or more corporate executives, employees, directors, or others with the insurance proceeds to be paid to Business 102 or its designee or surrogate/strawman. The premiums on this policy can be paid from the tax savings generated by the Business Charitable Equity Options.

FIG. 7A illustrates one example of a process for managing a Business Charitable Equity Options for high-income years. As shown, at step 702, Business 102 issues equity option grant to Charity 112, entitling Charity 112 to purchase equity interest in Business 102 at bargain price in a future year in which Business 102 income reaches a specified amount. In another embodiment, Business 102 may grant Charitable Equity Options to more than one charitable organization, or Business 102 may designate one or more of a variety of different “triggering events,” such as the approval of a patent, the opening of a new office, the unveiling of a new retail line, or the like.

At step 710, upon Business 102 income reaching the specified amount, Charity 112 tenders the bargain purchase price to Business, 102 and, at step 708, Business 102 transfers the equity interest to Charity 112. In one embodiment, step 710 may occur before step 708, after step 708, or concurrently.

At step 704, Business 102 is entitled to a charitable deduction for the difference between the bargain price paid by Charity 112, and the then-fair market value of the equity interest transferred to Charity 112.

At step 712/714, if Business 102 has insured lives of one or more executives, Business 102 receives life insurance proceeds on death of insured.

FIG. 7B illustrates one example of a logic flow for managing a Business Charitable Equity Options for high-income years. Process 700B of FIG. 7B begins at step 702 where Business 102 grants to Charity 112, an option to purchase an equity interest in Business 102 at bargain price in a future year when the option becomes exercisable. The option will become exercisable by Charity 112 if certain specified event(s) occur or if certain conditions are present or the like.

The option may be granted with a document, a series of documents, an email or letter exchange, phone call, or live meetings, or any mechanism of communication. The option need not satisfy any contract requirements, so long as the business actually does accept a sum (or other asset) from a charity (or alternatively, accepts a “cashless” exercise) and gives the charity equity units. The option grant document can (but need not) specify the terms or conditions as to when the option can be exercised.

The option may grant Charity 112 the express right to exercise. However, there need not be, but usually is, some sort of enforceable power or right in Charity 112. For example, the grant can provide that Business 102 has no obligation at all to the Charity 112, and if Business 102 grants the equity interests, Business 102 does so without legal compulsion.

In an alternate embodiment, at step 702, a third-party may issue the option grant to Charity 112 on behalf of Business 102. Possible issuers include: a subsidiary of the business, an executive at the business; an executive at an affiliated business; a retiree; a past or present board member; more than one such executive, retiree, or board member; an affiliated firm; an agent for the business, such as a bank, investment banker, broker, attorney, accountant, etc.; any other surrogate, strawman, or alter ego of the business.

In an alternate embodiment, at step 702, the option may be granted to a number of different charities, a group of charities, a trust of whom charities are the beneficiary, any type of surrogates, straw men, or alter egos for one or more charities, or the like.

Processing next continues to block 706, where Business 102, or its surrogate/strawman or designee, buys an insurance policy for a life of at least one person (e.g. Executive 118) for whom the Business 102 has an insurable interest, from Insurance Entity 114. At step 706, a premium may also be paid for the life insurance policy.

Processing next continues to decision step 707, where it is determined whether the exercise condition/event provided in the option has occurred or exists. The condition/event may be any determinable state, including whether Business 102 has income of more than an amount for number of years in a row, whether Business 102 has a patent approved, whether three years from the date of issuance of this grant has occurred, or the like. If it is determined that the exercise condition/event has occurred, processing continues to step 708. Otherwise, processing loops back to decision step 707 for further processing.

Processing next continues to block 708, where Charity 112 tenders to Business 102 the bargain price—e.g., a specified price (usually called a “strike price” in other option realms, such as employee stock options, e.g.).

Processing next continues to block 708, where Business 102 provides Charity 112 equity interests in Business 102 (i.e., stock if the issuing business is a corporation, units if the business is an LLC, etc). While preferably, it is the Business 102 itself which transfers the equity units to Charity 112, any direct or indirect agent, surrogate, strawman, or other representative of the business can make the transfer. Also, while the equity units are standard units of equity or ownership in the business (i.e., common stock in a corporation, membership units in an LLC), the equity units can be different than “standard” units, including a virtually limitless array of possible interests, including without limitation, preferred stock, “type A” units, restricted stock, special “charitable ownership interest” units, or the like.

Processing next continues to block 711, where Business 102 receives a charitable deduction (including tax deduction, credit or exemption) for tendering the equity to Charity 112. Business 102 receives the charitable deduction in the taxable year in which the equity interests are issued to the charity, equal to the difference, or “spread” between the strike price and the fair market value of the equity interests issued to the charity. The charitable deduction can be provided under federal, state or local law, as opposed to a federal income tax deduction.

At step 712, it is determined whether a person whose life is insured under the life insurance policy has died. If the person has died, then processing continues to step 714. Otherwise, processing continues to other steps.

At step 714, if Business 102 has insured lives of one or more persons, directors, and/or employees by buying an insurance policy from Insurance Entity 114, Business 102 (or any other party designated by Business 102) receives life insurance proceeds on the death of the insured (e.g. immediately, or spread over a term of years, or the like). Processing then continues to other steps.

At least in some embodiments, managing the insurance polices may be optional. Thus, in these embodiments, steps 706, 712 and 714, may not be performed.

The reader will appreciate that the Charity Equity Options for High Income Years (“CheEO”) provides particular qualities and advantages, including: the ChEOs uniquely afford the business the ability to pre-plan for future events with virtually limitless flexibility and precision; ChEOs afford the business the ability to pre-plan for the creation of charitable deductions in future years by planning now; ChEOs permit the business to choose the precise combination of strike price, vesting triggering event(s), and exercise format which most completely and advantageously meet its planning goals; the business can select the one or more charities as optionholders which it most desires to benefit, including its own charitable foundation; ChEOs require no outlay of cash or assets by the business to create; if and when ChEOs are exercised, the business's outlay is limited to equity units, including shares of stock in the case of a corporation, and involves no other outlay of cash or assets; and/or ChEOs afford the business the opportunity of favorable publicity and community goodwill both at the granting of the option and at the time of exercise of the option (and, if the optionholder is the business's own charitable foundation, at each time the foundation makes a grant to a public charity).

Accordingly, the reader will see that at least some embodiments of the invention provides the mechanism for the preplanning to lower Business 102's income tax liability in a future high-income year, and also the mechanism for Business 102 to provide funding to Charity 112, thus enhancing its community goodwill and favorable publicity, as well as the means to make up for the value of the equity interest transferred to Charity 112 via life insurance.

G. Illustrative Shareholder Protection Tool for Disclosure of Business Charitable Contributions Embodiments

Shareholders currently have little or no effective means of determining what charitable contributions a business is making to what charities. However, several little-known provisions of the Internal Revenue Code and Treasury Regulations, for example Section 25.2511-1 of the Treasury Regulations, actually require shareholders to report their proportionate share of all charitable contributions made by the corporation. This requirement in turn can impose an obligation on the corporation's board and officers to provide fully detailed information about all corporate charitable contributions to all shareholders annually, including the name of each charitable recipient, the date of the contribution, and the amount of the contribution.

In accordance with one embodiment of the invention, assume that the board of Business 102 makes a charitable contribution to Charity 112 of $3,500,000 during Year 1. Under applicable (though little-known) federal law, each shareholder of Business 102 is required to report his or her proportionate share of this contribution to the IRS. Using these provisions, Shareholder Action Group S compels Business 102 to provide all information regarding the contribution as is reasonably necessary to permit the shareholders to comply with this legal reporting requirement.

Among the key advantages for shareholders is an ability to obtain needed information about the corporation's charitable contributions, about which the corporation might otherwise keep the shareholders partially or wholly uninformed, an ability to scrutinize significant “hidden” expenditures made by the board or officers, to determine whether these are in fact in the best interests of the corporation and its owners, a tool to help stop the misuse of corporate fisc by self-seeking board members and officers, and that the request (demand) for this information about charitable contributions can be made either by the shareholder or his, her or its surrogate/strawman, including without limitation a shareholders' protection group

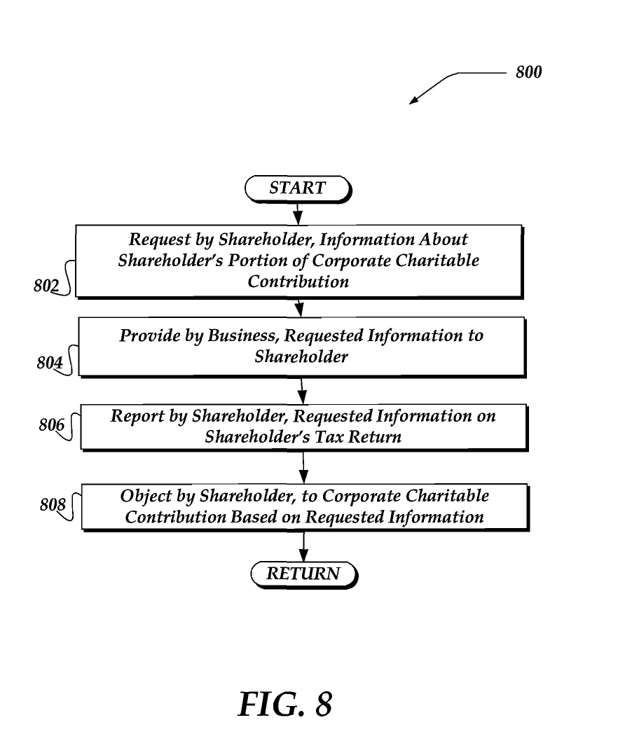

FIG. 8 illustrates one example of a logic flow for managing a Shareholder Protection Tool for Disclosure of Business Charitable Contributions. Process 800 of FIG. 8 begins at step 802 where a shareholder requests information re his or her (or its) proportionate share of all corporate charitable contributions made for the previous taxable year, on the strength of the Treasury Regulation requirement. The request can be made in person, via phone, fax, email, letter, or any means of communication. In one embodiment, the request (demand) for this information about charitable contributions can be made either by the shareholder or his, her or its surrogate/strawman, including without limitation a shareholders' protection group.

Processing next continues to block 804, where Business 102, via its directors and/or management, however unwillingly, must convey this information to the shareholder(s)/shareholders' protection group. The response can be by any means of communication.

Processing next continues to block 806, where the shareholder(s)/shareholders' protection group reports his, her or its share of the contribution on his, her, or its income tax return.

Processing next continues to block 808, the shareholder(s)/shareholders' protection group can use this information to raise objections to, or dissent from, such charitable contributions. Processing then continues to other steps.

Accordingly, the reader will see that at least some embodiments of the invention provides the mechanism for the shareholders or other business owners to obtain disclosure of information about charitable contributions made by the businesses they own.

H. Alternate Embodiments

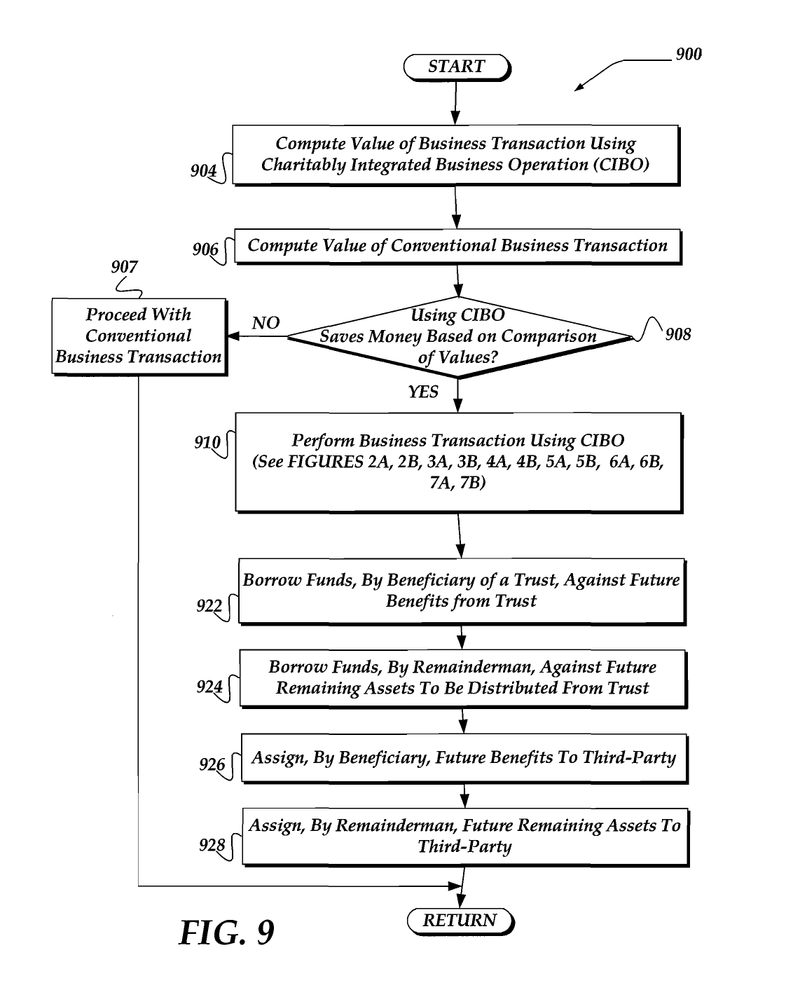

FIG. 9 shows a process for determining whether to perform a business transaction using a Charitably Integrated Business Operation (CIBO™) based on a valuation calculation. Process 900 of FIG. 9 begins at step 904, where a valuation is determined for a business transaction performed by Business 102 using at least one of various CIBO™ (s) described in FIGS. 1B-7B above. The business transactions can include performing an M&A, business asset sale, business liability funding, business executive compensation, or the like. In one embodiment, the valuation of the business transaction may be computed as the net or gross profits plus any tax deductions (including credits and exemptions), and plus any change in good will due to performing the CIBO™ (s) (e.g., funding Charity 112), or based on virtually any valuation calculation for a business transaction.

In one embodiment, the value calculation includes a Net Present Value (NPV) analysis of any future assets, funds, deductions, or the like, received by any combination of the parties involved in the business transaction. The value calculation can include computing the NPV for a future remaining asset and/or a plurality of future recurring benefits (e.g., income stream) received by Business 102, Charity 112, and/or a third-party (e.g., an employee, Buyer 105, surrogate/strawman of Business 102 and/or Buyer 105, or the like). The NPV can be calculated by the following formula, where t is the amount of time (usually in years) that cash has been invested in a project, N the total length of the project, i the discount rate (e.g., an interest rate), and C the cash flow at that point in time.

$$NPV = {\sum }_{t = 0}^{N} \frac{{C}_{t}}{{( 1 + i )}^{t}}$$

One of ordinary skill in the art will appreciate that the above formula can be modified to account for uneven value flows (including cash flows, asset flows, or the like), the use of a yield curve to give different discount rates for the various time points on the calculation, and the like. In one embodiment, the NPV can be computed over a term of years of Trust 108 (e.g., 20 years). In another embodiment, almost any discounted cash flow analysis can be used to compute the value of a business transaction using a CIBO™.

Processing next continues to block 906, where valuation of performing the business transaction in a conventional manner (e.g., without using the CIBO™ is computed. In one embodiment, the valuation includes at least in part an NPV of performing the business transaction in a conventional manner.

In one embodiment, at step 904 and 906, a computing device may be configured to determine the valuation of performing the business transaction with and without using the CIBO™. The valuation may calculated based on entered assumptions, variables, or the like, from Business 102. For example, the NPV may be calculated in a spread-sheet, or the like, showing the change in cash flow, over a period of time, or the like

Processing next continues to decision block 908, where it is determined whether using the CIBO™ in the business transaction saves the parties (e.g., Business 102, Buyers 105, and/or Charity 112) money based on a comparison of the valuations of the business transactions using the CIBO™ and without using the CIBO™. If it is determined that the value of performing the business transaction using the CIBO™ is greater than (or greater than or equal to, substantially greater than, or the like) the value of performing the business transaction in a conventional manner, then processing continues to step 910. Otherwise, processing continues to step 907 where the business transaction is performed in the conventional manner. In an alternate embodiment, at least one of the valuations may be provided to a decision maker of Business 102. The decision maker may use the determined valuation(s) as a basis for a decision whether to proceed with a business objective using the CIBO™ at step 910, or in a conventional manner at step 907.

In one embodiment, at step 908, a computing device may be configured to determine whether using the CIBO™ in the business transaction results in savings to any of the parties (e.g., Business 102, Buyers 105, and/or Charity 112). The determination may be based on a valuation (e.g. NPV valuation) of the transaction from the perspective of each of the parties. The computing device may be configured to make the determination by comparison logic, or the like.

At step 910, the business transaction is performed using a CIBO™. CIBO™(s) are described in FIGS. 1B-7B above. For example, the business transaction may be performed using a CRT, CLT, life-estate, or the like.

Processing then continues to step 922, where a trust (e.g., Trust 108) is used in the CIBO™, a beneficiary (e.g., Business 102, Charity 112, a third-party) of a recurring benefit(s) of the trust can borrow funds against the future recurring benefit(s), to enjoy immediate liquidity. This can be done as soon as Trust 108 is established, or at any other time (or more than one time) during the term of Trust 108. In one embodiment, the beneficiary can secure a loan based at least in part on a collateral of the plurality of recurring benefit(s).

Processing then continues to step 924, where a trust is used in the CIBO™, a remainderman (e.g., Business 102, Charity 112, a third-party) of the trust can borrow funds against the future remaining asset of the trust, to enjoy immediate liquidity. This can be done as soon as Trust 108 is established, or at any other time (or more than one time) during the term of Trust 108. In one embodiment, the beneficiary can secure a loan based at least in part on a collateral of the remaining asset. This borrowing will afford Charity 112 immediate liquidity, so that it need not have to wait till the expiration of term of Trust 108 to start doing good deeds in the community, or the like. In lending Charity 112, a bank can fulfill its requirements under the Community Reinvestment Act (CRA) and can enhance its Capital adequacy, Asset quality, Management, Earnings and Liquidity (CAMEL) rating.

Processing next continues to step 926, where the beneficiary can sell or assign its recurring benefit(s) (e.g., income stream) from Trust 108 at any time during Trust 108's term, either to another business, a third party, or a division or subsidiary of itself, etc. etc—no limits on who could be or be transferee.

Processing next continues to step 928, where the remainderman can sell or assign its interest in Trust 108 to a third-party (e.g., Executive 118, Buyer 105, a surrogate/strawman of any of the components of FIG. 1). Processing then continues to other steps.

Accordingly, the reader will see that at least some embodiments of the invention provides the mechanism for the shareholders or other business owners to obtain disclosure of information about charitable contributions made by the businesses they own.

It will be understood that the steps of the flowchart illustrations described herein can be performed in different orders and some steps may be omitted, without departing from the spirit of the invention.

It will also be understood that certain steps in the flowchart illustrations, and combinations of steps in the flowchart illustrations, can be implemented by computer program instructions. These program instructions can be provided to a processor to produce a machine, such that the instructions, which execute on the processor, create means for implementing the actions specified in the flowchart step or steps. The computer program instructions can be executed by a processor to cause a series of operational steps to be performed by the processor to produce a computer implemented process such that the instructions, which execute on the processor to provide steps for implementing the actions specified in the flowchart step or steps. The computer program instructions can also cause at least some of the operational steps shown in the steps of the flowchart to be performed in parallel. Moreover, some of the steps may also be performed across more than one processor, such as might arise in a multi-processor computer system.

Accordingly, steps of the flowchart illustrations support combinations of means for performing the specified actions, combinations of steps for performing the specified actions and program instruction means for performing the specified actions. It will also be understood that each step of the flowchart illustrations, and combinations of steps in the flowchart illustrations, can be implemented by special purpose hardware-based systems which perform the specified actions or steps, or combinations of special purpose hardware and computer instructions. Further, it should be understood that aspects of any particular embodiment can be combined with features and aspects of other embodiments in practicing the present invention.

Since many embodiments of the invention can be made without departing from the spirit and scope of the invention, the invention is to be defined by the claims hereinafter appended.

What is claimed is:

1. A method in support of charitable giving in furtherance of a business objective of the business, comprising the step of proceeding with the business objective in response to a decision by a decision maker by:
(a) establishing a trust to achieve at least a part of the business objective, the trust having a term, the trust being either a charitable remainder trust or a charitable lead trust;
(b) transferring one or more assets of the business to the trust;
(c) disposing of at least one asset within the trust in furtherance of the business objective; and
(d) passing benefits resulting from the disposition of the at least one asset from the trust while shielding the business from a tax liability due to the disposing step, if the tax liability is owing.

2. The method of claim 1, wherein the established trust is the charitable remainder trust, the charitable remainder trust being a tax-exempt entity, including the additional step of designating a charity as a remainderman of the trust which is entitled to a remainder interest in at least a portion of a value of the one or more transferred assets.

3. The method of claim 2, wherein the business objective is to complete a merger or an acquisition of assets, wherein the trust that is established is the charitable remainder trust, wherein the step of disposing comprises performing a tax-exempt sale of the at least one asset, and wherein the step of passing the benefits comprises receiving a charitable income tax deduction of a present value of the remainder interest.

4. The method of claim 2, wherein the business objective is to complete an asset sale of the one or more assets, wherein the trust that is established is the charitable remainder trust, wherein the step of disposing comprises performing a tax-exempt sale of the at least one asset, and wherein the step of passing the benefits includes receiving a charitable income tax deduction of a present value of the remainder interest.

5. The method of claim 2, wherein the business objective is to satisfy a liability of the business, and wherein the step of passing the benefits comprises passing the benefits is performed in a generally temporally aligned time frame with any payments due on the liability.

6. The method of claim 5, including the additional step of satisfying the liability based at least in part a portion of the passed benefits.

7. The method of claim 1, wherein the business objective is to shift an unwanted income stream to or through a charity, wherein the trust is the charitable lead trust and the charity is a beneficiary of the trust entitled to distributions from the trust in the form of an annuity or a percentage of a value of the assets transferred to the trust, the trust further being a taxable entity and the charity further being a tax-exempt entity, wherein the step of disposing comprises distributing the unwanted income stream to the charity, and wherein the step of passing the benefits comprises providing a savings to the business through a reduction of an income tax liability of the business.

8. The method of claim 7, including the additional step of revaluing annually, during the trust term, the value of the assets transferred to the trust.

9. The method of claim 1, wherein the step of establishing the trust comprises designating a charity as either a remainderman or a beneficiary of the trust, and wherein the step of passing the benefits comprises:
distributing to the beneficiary at least one of the benefits over the term of the trust; and
distributing to the remainderman a remaining asset of the trust at the end of the term of the trust.

10. The method of claim 9, wherein the other one of the remainderman or the beneficiary is either the business, a recipient to whom a liability of the business is owed, an employee of the business, a surrogate of the business, or a designee of the business.

11. The method of claim 1, including the additional step of receiving, by the business or owners of the business, an income tax deduction as a result of having transferred the one or more assets of the business to the trust.

12. The method of claim 11, including the additional step of taking the income tax deduction on a tax return filed with a state or a federal government.

13. The method of claim 11, wherein the business is a pass-through entity, and further comprising the additional step of apportioning the income tax deduction among the owners of the business.

14. The method of claim 11, wherein the step of establishing the trust further comprises:
providing in a trust-governing document powers to a trustee including that the trustee is empowered to:
sell the one or more assets in return for a payment; and
use the payment to provide the recurring benefit of the trust.

15. The method of claim 1, wherein proceeding step is selectively performed after the additional steps of determining a valuation of any income or deduction available to the business as a result of performing steps (a)-(d) and providing the determined valuation to the decision maker.

16. The method of claim 15, including the additional step of using the determined valuation as a basis for the decision whether to proceed with the business objective by performing steps (a)-(d).

17. The method of claim 9, including the additional step of compensating for the distribution of the remaining asset of the trust to the remainderman, at the end of the term of the trust, by:
purchasing a life insurance policy for a life of a person in whose life the business has an insurable interest;
paying at least one premium on the life insurance policy; and
collecting a proceed from the life insurance policy upon a death of the person.

18. The method of claim 9, including at least one of the additional steps of:
the beneficiary securing a loan based at least in part on a collateral which includes the benefits, or
the remainderman securing another loan based at least in part on a collateral which includes the remaining asset.

19. A method for passing benefits using an established trust in furtherance of a business objective of a business, the trust being of the type having a term and one or more assets, comprising the steps of:
(a) disposing of at least one asset within the trust in furtherance of the business objective, wherein the trust is either a charitable remainder trust or a charitable lead trust and wherein a charity is either a remainderman or a beneficiary of the trust;
(b) distributing a recurring benefit from the trust to the beneficiary over a term of the trust in furtherance of the business objective;
(c) distributing a remaining asset of the trust to the remainderman, at an end of the term of the trust; and
(d) shielding the business of a tax liability due to the disposing step, if the tax liability is owing.

20. The method of claim 19, wherein the established trust is the charitable remainder trust, the charitable remainder trust being a tax-exempt entity and the charity being a remainderman of the trust entitled to a remainder interest in at least a portion of a value of the one or more transferred assets.

21. The method of claim 20, wherein the business objective is to complete a merger or acquisition of assets, wherein the trust which is established is the charitable remainder trust, wherein the step of disposing comprises performing a tax-exempt sale of at least a portion of the one or more assets, and wherein the step of distributing the recurring benefit comprises receiving a charitable income tax deduction of a present value of the remainder interest.

22. The method of claim 20, wherein the business objective is to complete an asset sale of the one or more assets, wherein the trust which is established is the charitable remainder trust, wherein the step of disposing comprises performing a tax-exempt sale of at least a portion of the one or more assets, and wherein the step of distributing the recurring benefit includes receiving a charitable income tax deduction of a present value of the remainder interest.

23. The method of claim 20, wherein the business objective is to satisfy a liability of the business, and wherein the step of distributing the recurring benefit is performed in a generally temporally aligned time frame with any payments due on the liability.

24. The method of claim 23, including the additional step of satisfying the liability based at least in part on a portion of the passed benefits.

25. The method of claim 19, wherein the business objective is to shift an unwanted income stream to or through a charity, the trust which is established is the charitable lead trust, the charity is a beneficiary of the trust entitled to distributions from the trust in the form of an annuity or a percentage of a value of assets of the trust, the trust is a taxable entity, the charity is a tax-exempt entity, the step of disposing comprises distributing the unwanted income stream to the charity, and the step of passing the benefits comprises providing a savings to the business through a reduction of an income tax liability of the business.

26. The method of claim 25, including the additional step of revaluing annually, during the trust term, the value of the assets of the trust.

27. The method of claim 19, wherein the other one of the remainderman or the beneficiary is either the business, a recipient to whom a liability of the business is owed, an employee of the business, a surrogate of the business, or a designee of the business.

28. The method of claim 19, wherein the trust is subject to a trust-governing document that provides powers to a trustee including that the trustee is empowered to:
sell the at least one asset in return for a payment; and
use the payment to provide the recurring benefit of the trust.

29. The method of claim 19, including the additional step of compensating for distributing the remaining asset of the trust to the remainderman, at the end of the term of the trust, by:
purchasing a life insurance policy for a life of a person in whose life the business has an insurable interest;
paying at least one premium on the life insurance policy; and
collecting a proceed from the life insurance policy upon a death of the person.

30. The method of claim 19, including at least one of the additional steps of:
the beneficiary securing a loan based at least in part on a collateral which includes the recurring benefit, or
the remainderman securing another loan based at least in part on a collateral which includes the remaining asset.
